(19) United States
(12) Patent Application Publication
(10) Pub. No.: US 2026/0277661 A1
(43) Pub. Date: Sep. 17, 2026

(54) BATCH FOLDING FOR PARALLELIZED MULTIUSER COMPUTATIONS

(71) Applicant: Groq, Inc., San Jose, CA (US)

(72) Inventors: Chenyu Wang, Toronto (CA); Kyeong Mo Kang, Mississauga (CA); Pao-Sheng Chou, Toronto (CA)

(21) Appl. No.: 19/565,110

(22) Filed: Mar. 12, 2026

Related U.S. Application Data
(60) Provisional application No. 63/771,434, filed on Mar. 13, 2025.

(51) Int. Cl. G06F 9/48

(52) U.S. Cl. CPC G06F 9/4806

(57) ABSTRACT

A method can provide for obtaining, by a computing system comprising one or more computing devices, first input data respective to a first generation task; obtaining, by the computing system, second input data respective to a second generation task; providing, by the computing system, the first input data and the second input data to an attention mechanism of a batched transformer model to generate a shared context based on the first input data and the second input data; batching, by the computing system, the shared context to produce a first batch associated with the first input data and a second batch associated with the second input data; and performing, by the computing system, a first operation on the first batch while masking a portion of the shared context corresponding to the second batch.

### CROSS-REFERENCE TO PRIORITY APPLICATION

The present disclosure claims the benefit of priority to U.S. Provisional Application No. 63/771,434, entitled “BATCH FOLDING FOR PARALLELIZED MULTIUSER COMPUTATIONS,” filed Mar. 13, 2025, the entirety of which is incorporated by reference herein.

### FIELD

The present disclosure relates generally to systems and methods for performing computing operations, such as machine-learned inference operations.

### BACKGROUND

Machine learning is an artificial intelligence technique in which a computing device can “learn” from training data, such as training data obtained from a static training dataset or an interactive learning environment. For example, a computing system can obtain a training dataset; initialize a machine learning model comprising a plurality of parameters (e.g., untrained parameters such as randomly generated starting parameters, etc.); and train the parameters based on the training dataset. The trained machine-learned model can then be used to perform various operations, such as prediction operations, generative artificial intelligence operations (e.g., language generation, image generation, audio generation, video generation, etc.), automation operations (e.g., hardware automation such as robot or automobile automation, software automation such as web browser or user interface automation, etc.), reasoning operations, agentic operations, or other machine learning operations. Operations performed by a trained machine-learned model can be referred to as machine-learned inference operations.

### SUMMARY

Aspects and advantages of embodiments of the present disclosure will be set forth in part in the following description, or can be learned from the description, or can be learned through practice of the embodiments.

In an aspect, the present disclosure provides a computer-implemented method for batch folding for parallelized multiuser computations. The method includes obtaining, by a computing system comprising one or more computing devices, first input data respective to a first generation task. The method includes obtaining, by the computing system, second input data respective to a second generation task. The method includes providing, by the computing system, the first input data and the second input data to an attention mechanism of a batched transformer model to generate a shared context based on the first input data and the second input data. The method includes batching, by the computing system, the shared context to produce a first batch associated with the first input data and a second batch associated with the second input data. The method includes performing, by the computing system, a first operation on the first batch while masking a portion of the shared context corresponding to the second batch.

In an aspect, the present disclosure provides a computing system. The computing system includes one or more processors and one or more non-transitory, computer-readable media storing instructions that, when implemented, cause the one or more processors to perform operations. The operations include obtaining first input data respective to a first generation task. The operations include obtaining second input data respective to a second generation task. The operations include providing the first input data and the second input data to an attention mechanism of a batched transformer model to generate a shared context based on the first input data and the second input data. The operations include batching the shared context to produce a first batch associated with the first input data and a second batch associated with the second input data. The operations include performing a first operation on the first batch while masking a portion of the shared context corresponding to the second batch.

In an aspect, the present disclosure provides one or more non-transitory, computer-readable media storing instructions that, when implemented, cause one or more processors to perform operations. The operations include obtaining first input data respective to a first generation task. The operations include obtaining second input data respective to a second generation task. The operations include providing the first input data and the second input data to an attention mechanism of a batched transformer model to generate a shared context based on the first input data and the second input data. The operations include batching the shared context to produce a first batch associated with the first input data and a second batch associated with the second input data. The operations include performing a first operation on the first batch while masking a portion of the shared context corresponding to the second batch.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 illustrates a diagram of an example transformer model according to example aspects of the present disclosure;

FIGS. 2A-2B illustrate a logic diagram of an example transformer model according to example aspects of the present disclosure;

FIG. 3 is a block diagram of an example processor device according to example implementations of aspects of the present disclosure;

FIG. 4 is a block diagram of an example processor device according to example implementations of aspects of the present disclosure;

FIG. 5 is a block diagram of an example tensor streaming processor device according to example implementations of aspects of the present disclosure; and

FIG. 6 is a flowchart diagram of a method for batch folding for parallelized multiuser computations according to example implementations of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations may be made to the embodiments without departing from the scope or spirit of the present disclosure. For instance, features illustrated or described as part of one embodiment may be used with another embodiment to yield a still further embodiment. Thus, it is intended that aspects of the present disclosure cover such modifications and variations.

Example embodiments according to aspects of the present disclosure are directed to systems and methods for batch folding for parallelized multiuser computations.

Large language models (LLMs) are used in generative artificial intelligence applications for a variety of purposes, such as for programming assistants, chatbots, etc. LLMs are at the center of the recent rapid progress in artificial intelligence (AI).

One example large language model can utilize a transformer model (or simply “transformer”). Transformers are used for large language models that have seen widespread applicability to deep learning tasks including generation and/or recognition tasks and on a variety of data types including image data, audio data, video data, and/or other data types such as simulation data of complex problem spaces such as those in biological modeling, chemical modeling, or physical modeling. Transformer models can operate on a sequence of data. Individual items within the sequence can be referred to as “tokens.” For example, in a text generation task, a token can refer to a word within a larger sequence of words (e.g., a phrase, sentence, paragraph, etc.) processed by the transformer. Generally, transformer models can be used to predict a most probable next token (or plurality of tokens) given an input. The input can include, for example, input from a user (e.g., a query), other input used to condition the generation from the model, prior tokens generated by the transformer, or other suitable input, collectively referred to as the “generation context” or simply “context” of a generation task.

A transformer model can include one or more transformer blocks that collectively perform the majority of the processing operations performed by the transformer model. A transformer block can include an attention mechanism and a feed forward (FF) layer or FF network. One example FF network is a multilayer perceptron (MLP) layer. The attention mechanism is a useful component of transformer models that provides for the transformer model to capture dependencies, such as contextual relationships, between tokens, including tokens that are not necessarily close in proximity within the input sequence.

In some cases, tokens may be, or may be converted into, embedded or encoded representations, such as numerical representations (e.g., embeddings) that encode the semantic meaning of the tokens into processable form. For instance, in some implementations, a transformer model can include an embedding layer (or layers) that can convert input data into a form that the transformer model can process, such as an embedding or encoding. As one example, the embedding layer can tokenize the input. Tokenizing the input can include dividing the input data into a plurality of tokens. For example, tokenizing text data can include breaking a larger phrase into multiple words or subwords. The set of unique tokens that may be understood by a transformer model can be referred to as the vocabulary of the model.

Additionally or alternatively, the embedding layer can convert the (e.g., tokenized) input data into token embeddings. The token embeddings can be a tensor (e.g., vector) having a dimensionality. The dimensionality of the token embeddings can vary depending on the transformer model. For example, in some cases, token embeddings can be an N-dimensional vector. The set of token embeddings in an input can be stored in an I by N matrix where I is the number of token embeddings derived from the input. Other suitable approaches of representing input to a transformer model can also be used in accordance with the present disclosure. Additionally or alternatively, in some implementations, the embedding layer can encode information about the position of a token relative to the input sequence. For instance, in some implementations, the information about the position of a token may be encoded separately from the matrix of token embeddings. Additionally and/or alternatively, in some implementations, the information about the position of a token may be correlated to the position of the respective token embedding in the set of token embeddings. Still further, in some implementations, the token embedding may be combined (e.g., summed, appended, etc.) with the position encoding to generate an embedded representation of each token representative of semantic and/or positional information of the token.

A transformer can include one or more transformer blocks. The transformer blocks can, for example, be “stacked” or otherwise arranged in a sequence. A transformer block can include an attention mechanism or self-attention mechanism that conceptually “focuses” the evaluation of the model on portions of an input sequence. The attention mechanism can receive an input sequence (e.g., an embedding representation vector) and transform the input sequence into a query (Q) vector, key (K) vector, and value (V) vector (or, more generally, tensor(s)). As one example, the input sequence can be multiplied by a respective weight matrix for each vector, such as, for example, a Q matrix, a K matrix, and/or a V matrix. The values of weights in the weight matrices can, for example, be learned during training of the transformer model. Additionally and/or alternatively, the Q vector, K vector, and/or V vector may be biased by a respective bias (e.g., a Q bias, K bias, and/or V bias). The Q, K, and V vectors can, for example, provide an expanded evaluation space for representing relationships between source and target tokens. Conceptually, the Q, K, and V pairs can be analogized to a search representative of pairwise similarity between tokens. The query, Q, represents a value being searched for. The key, K, represents the comparison baseline. The value, V, represents an associated weight for each “found” token.

In some implementations, the attention mechanism can be a multi-head attention mechanism. The multi-head attention mechanism can divide the Q, K, and V vectors among multiple heads that independently process the input sequence. Conceptually, each head of the multi-head attention mechanism can capture distinct relationships within the input sequence.

The attention mechanism can calculate an attention score for each token using the Q, K, and V vectors. The attention score can be representative of the relevance of each token when generating predictions. As one example, the attention score can be computed based on a dot product between the Q vector and the K vector. The dot product can, for example, represent the alignment between respective key-query pairs. The attention scores can be represented as a matrix (e.g., a square matrix with a dimension equivalent to that of the sequence length of the Q and K vectors or the input sequence). In some implementations, the attention scores may be masked to force zero attention scores for “future” tokens in a sequence. Furthermore, in some implementations, the attention scores may be normalized by a normalization operation to convert the attention score matrix from scalar values into probability from zero to a constant value (e.g., one). The normalization operation can, for example, be a generalization of a logarithmic operation to multiple dimensions. The normalization operation can normalize each row of the attention score matrix such that each row (or column) in the matrix sums to a constant value (e.g., one). One example normalization operation is a SoftMax operation.

The attention scores (e.g., subsequent to being normalized to probability by the normalization operation) can be multiplied with the value matrix. This QK×V matrix can represent the output of the attention mechanism. In the case of a multi-head attention mechanism, the output of each head can be concatenated and/or projected into a common dimensionality with the input sequence.

The output of the attention mechanism can be provided to the feed forward (FF) layer. The structure of the FF layer can vary depending on the type of transformer model. One example FF layer is a multilayer perceptron (MLP) layer that includes linear transformations and/or activation functions. The linear transformations can increase or decrease dimensionality of the input. As one example, the MLP layer can include a first linear transformation that increases a dimensionality of the input to an intermediate representation and a second linear transformation that reduces the dimensionality of the intermediate representation back to the dimensionality of the input. In some implementations, unlike the attention mechanism, the linear transformations may map a token from one representation to another independently.

If the transformer model includes multiple transformer blocks, the output of the FF layer of one transformer block can be provided as input to the (e.g., attention mechanism of the) subsequent transformer block. Furthermore, in some implementations, the transformer model can include a prediction layer. The prediction layer can project the output of the FF layer (e.g., of the final transformer block) to a prediction space. The dimensionality of the prediction space can be based on the vocabulary of the transformer model. For example, in some implementations, the projection into the prediction space generates a probability tensor having a unique probability value (which may be referred to as a logit) for each candidate token in the vocabulary of the transformer model. In some implementations, the probability tensor is normalized (e.g., by a SoftMax function) such that the probability tensor represents a probability distribution that sums to a constant value (e.g., one). A maximum (or, in some configurations, a minimum or other optimum value) value within the probability tensor can therefore correspond to a most likely token in the sequence. One or more tokens can therefore be sampled with respect to the probability distribution defined by the probability tensor.

While the description above relates to some implementations of a transformer model, it should be understood that variations in the architecture of a transformer model are contemplated within the scope of the present disclosure. As one example, in some implementations, transformer models may use a key-value cache (KV cache) to avoid redundant computations by storing the intermediate results of the self-attention mechanism, such as the key and value vectors, computed during the forward pass for each processed input token. When generating subsequent tokens, the model retrieves and reuses these cached key-value pairs, allowing the model to compute the self-attention for new tokens without recalculating the attention for previously processed tokens.

Additionally, in some implementations, the throughput of transformer models may be improved by batching requests and processing multiple input sequences in parallel. For instance, in some implementations, the input sequence (also referred to as a “context” herein) can be divided (e.g., evenly) into a plurality of batches. The number of batches that the context is divided into can be specified by, for example, a batch dimension B. For example, if a transformer model has a sequence length (that is, a dimensionality of the context) of 8192 and a batch dimension of four, the context may be divided into four batches (e.g., batch 0 through 3) each representing generation tasks of 2048 tokens. Generation tasks within each batch may be performed concurrently, as if each batch represented a separate, related context.

Batching contexts can improve throughput and/or latency of transformer models. For example, in some instances, a transformer may process its entire sequence length irrespective of the number of meaningful tokens in the context, which may be less than the sequence length. For example, if a context is 1500 tokens but the transformer supports a sequence length of 8192, the remaining 6692 token spaces may be filled with null values or similar meaningless data, which may waste computational resources that could otherwise be used for processing meaningful data. By batching several smaller contexts into a single processing instance and utilizing a greater amount of the available sequence length, the batching approaches described herein can improve the functionality of computer-related technologies of machine learning by reducing computational resource waste associated with meaningless context values.

For instance, due to the increasing sequence lengths and uneven workloads in certain generation tasks, a number of tokens to be generated may be significantly lower than a per-batch context capability in many cases. As one example, in evaluation of decoder models, such as attention mechanisms of transformers, a context size (e.g., defined by batch and/or sequence length dimensions) may be on the order of hundreds of thousands, while users may only generate hundreds of tokens for some queries. If, for example, the context size is divided into batches, several batches may be null as the relatively few generation tasks are all located in a single batch. Furthermore, in some existing approaches, the matrix multiplication (MatMul) operations may be computed for each batch and sequence length per cycle (e.g., even if the results of that computation are not utilized). For example, in some implementations, due to the relative timing constraints of processing hardware, the generation of tokens may be synchronized to cycles (e.g., compute cycles, clock cycles) or other timing configuration that is independent of the values being computed.

According to example aspects of the present disclosure, to utilize otherwise unused compute resources in context compiles of a machine-learned model, a context can be divided and treated as different batches, which may respectively be assigned to different users. In the case where a single user will utilize a context larger than one batch, multiple batches are “folded” to produce a number of tokens that is greater than one batch length for that user. This configuration is referred to as batch folding. Batch folding provides for splitting a larger per-context generation task into smaller batches and generating tokens for multiple users (e.g., or multiple queries) in a single evaluation of the transformer model (e.g., a single pass through a transformer block). Because the generation tasks per user may generally be smaller than the context, assigning multiple users to batches of a context can more efficiently utilize the per-context evaluation capabilities of the machine-learned model. In some implementations, to divide the context into a plurality of batches, operations within the machine-learned model that operate on an entire sequence length of the context (e.g., SoftMax operations, query, key, value multiplication operations, etc.) can be selectively masked such that portions of the context not associated with a user (e.g., and/or associated with different users) are masked from the operations. Because some of these operations (e.g., SoftMax) scale with sequence length, reducing the sequence length by masking portions of these operations associated with different users can conserve computing resources associated with performing these operations (e.g., relative to performing these operations with “wasted” excess context as in some existing approaches).

In some implementations, the masking operation can be controlled to vary the portion of the context (e.g., a number and/or position of batches within the context) that is masked and/or not masked. For example, in some implementations, a batch select matrix can be used to generate a context mask that is applied at the masking operation. The batch select matrix can identify which batches within the context are masked or unmasked. As one example, consider a context having a sequence length of 8192 and a batch value of four. The sequence length of 8192 can therefore be divided into four batches, each having a length of 2048. The batches may be numbered and/or ordered, for example, as batch 0 (e.g., the first set of 2048 tokens in the context), batch 1 (e.g., the second set of 2048 tokens in the context), batch 2 (e.g., the third set of 2048 tokens in the context) and batch 3 (e.g., the fourth set of 2048 tokens in the context). The batch select matrix can indicate which of the batches (e.g., batch 0, batch 1, batch 2, or batch 3) are to be masked based on the context length utilized by a user.

The mask can be generated based on the token positions within the context corresponding to the batches in the batch select matrix. For example, if the batch select matrix indicates that batches 0 and 1 are to be unmasked and batches 2 and 3 are to be masked, then the batch select matrix may have a first value (e.g., 1) for the first and second columns in the first and second rows, and may have a second value (e.g., 0) in the third and fourth columns and/or in the third and fourth rows.

Masking out portions of the context at each operation can shorten the context and provide for tokens of multiple users to be processed in a single matrix multiplication. Furthermore, the present disclosure can provide for users to generate up to a sequence length worth of tokens by configuring the mask based on a batch select matrix that folds multiple batches together into a single processing operation. Batches that contain portions of the context folded together into a common batch can be processed to generate a combined output tensor from the attention mechanism common to the folded portions.

Aspects of the present disclosure can provide a number of technical effects and benefits, including improvements to computing technology and the computing-technology-related field of machine-learned model inference. For instance, aspects of the present disclosure can provide for providing first input data and second input data to an attention mechanism of a batched transformer model to generate a shared context based on the first input data and the second input data, batching the shared context to produce a first batch associated with the first input data and a second batch associated with the second input data, and performing a first operation on the first batch while masking a portion of the shared context corresponding to the second batch. At least performing the first operation on the first batch while masking a portion of the shared context corresponding to the second batch can reduce computational resource usage by preventing the utilization of computing resources associated with processing the masked portion of the shared context. This, in turn, can provide for reduced energy utilization and/or an increased amount of computational jobs associated with constant computing resources. Still further, at least performing the first operation on the first batch while masking a portion of the shared context corresponding to the second batch can provide for processing a first batch (e.g., corresponding to a first user/job) and a second batch (e.g., corresponding to a second user/job) concurrently, without values of tokens for the first batch affecting values of tokens for the second batch despite both batches being incorporated into a shared context. This can improve throughput of the model and increase an efficiency of computing resource utilization compared to processing the first batch and the second batch in separate contexts, thereby improving the number of users or jobs that can be processed with constant computing resources.

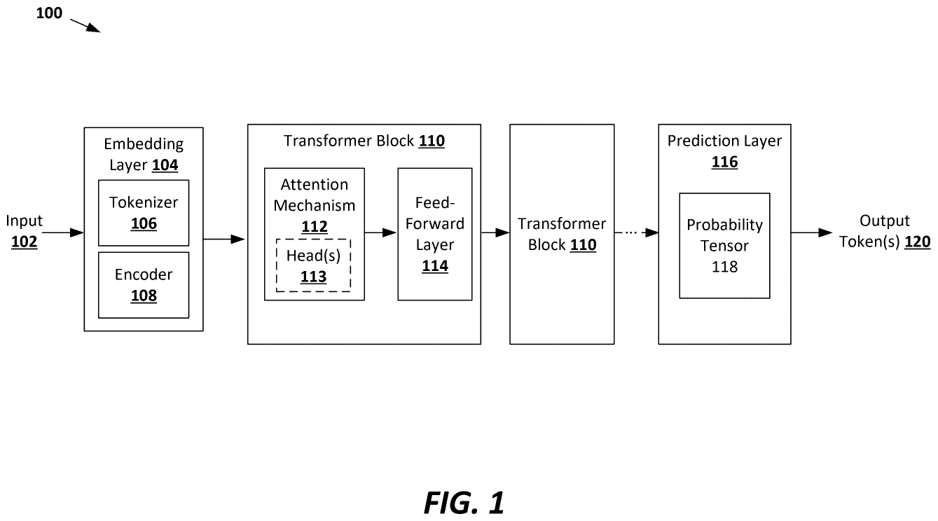

FIG. 1 depicts a first portion of a transformer model 100 according to example aspects of the present disclosure. The transformer model 100 can receive a transformer input 102. The transformer input 102 can include any suitable data such as, for example, text data, video data, audio data, and/or other suitable data. Furthermore, the transformer input 102 can include, for example, input from a user (e.g., a query), other input or context used to condition the generation from the model, prior tokens generated by the transformer model 100, or other suitable input.

In some cases, the transformer input 102 may be, or may be converted into, embedded or encoded representations. For instance, in some implementations, the transformer model 100 can include an embedding layer 104 that can convert the transformer input 102 into a form that the transformer model 100 can process. As one example, the embedding layer 104 can include a tokenizer 106 that can tokenize the transformer input 102. Tokenizing the transformer input 102 can include dividing the transformer input 102 into a plurality of tokens. For example, tokenizing text data can include breaking a larger phrase into multiple words or subwords. The set of unique tokens that may be understood by the transformer model 100 can be referred to as the vocabulary of the model 100.

Additionally or alternatively, the embedding layer can include an encoder 108 that can convert the (e.g., tokenized) transformer input 102 into token embeddings. The token embeddings can be a tensor (e.g., vector) having a dimensionality. The dimensionality of the token embeddings can be any suitable dimensionality. For example, in some cases, the token embeddings can include or can be represented by an N-dimensional vector. The set of token embeddings can be or can be represented as an I by N matrix where I is the number of token embeddings derived from the transformer input 102. Additionally or alternatively, in some implementations, the embedding layer 104 (e.g., the encoder 108 or another component, such as a position encoder) can encode information about the position of a token relative to the sequence of the transformer input 102. For instance, in some implementations, the information about the position of a token may be encoded separately from the matrix of token embeddings. Additionally and/or alternatively, in some implementations, the information about the position of a token may be correlated to the position of the respective token embedding in the set of token embeddings. Still further, in some implementations, the token embedding may be combined (e.g., summed, appended, etc.) with the position encoding to generate an embedded representation of each token representative of semantic and/or positional information of the token.

Additionally and/or alternatively, the transformer model 100 can include one or more transformer blocks 110. The transformer blocks 110 can, for example, be “stacked” or otherwise arranged in a sequence. A transformer block 110 can include an attention mechanism 112 (or self-attention mechanism) that conceptually “focuses” the evaluation of the model 100 on portions of the transformer input 102 based on computed attention scores. The attention mechanism 112 can receive an attention input (e.g., the model transformer input 102 and/or an embedding representation vector of the model transformer input, such as the output of the embedding layer 104) and transform the attention input into a query (Q) vector, key (K) vector, and value (V) vector (or, more generally, tensors). As one example, the attention input can be multiplied by a respective weight matrix for each vector, such as, for example, a Q matrix, a K matrix, and/or a V matrix. The values of weights in the weight matrices can, for example, be learned during training of the transformer model 100. Additionally and/or alternatively, the Q vector, K vector, and/or V vector may be biased by a respective bias (e.g., a Q bias, K bias, and/or V bias). The Q, K, and V vectors can, for example, provide an expanded evaluation space for representing relationships between source and target tokens. Conceptually, the Q, K, and V pairs can be analogized to a search representative of pairwise similarity between tokens. The query, Q, represents a value being searched for. The key, K, represents the comparison baseline. The value, V, represents an associated weight for each “found” token.

In some implementations, the attention mechanism 112 can be a multi-head attention mechanism. The multi-head attention mechanism can divide the Q, K, and V vectors among multiple heads 113 that independently process the attention input. Conceptually, each head 113 of the multi-head attention mechanism can capture distinct relationships within the input sequence.

The attention mechanism 112 can calculate an attention score for each token of the attention input using the Q, K, and V vectors. The attention score can be representative of the relevance of each token when generating predictions. As one example, the attention score can be computed based on a dot product between the Q vector and the K vector. The dot product can, for example, represent the alignment between respective key-query pairs. The attention scores can be represented as a matrix (e.g., a square matrix with a dimension equivalent to that of the sequence length of the Q and K vectors or the input sequence). In some implementations, the attention scores may be masked to force zero attention scores for “future” tokens in a sequence. Furthermore, in some implementations, the attention scores may be normalized by a normalization (e.g., SoftMax) operation to convert the attention score matrix from scalar values into probability from zero to a constant value (e.g., one). The normalization operation can, for example, be a generalization of a logarithmic operation to multiple dimensions. The normalization operation can normalize each row of the attention score matrix such that each row (or column) in the matrix sums to a constant value (e.g., one). The attention scores (e.g., subsequent to being normalized to probability by the normalization operation) can be multiplied with the value matrix. This QK×V matrix can represent the output of the attention mechanism 112. In the case of a multi-head attention mechanism, the output of each head 113 can be concatenated and/or projected into a common dimensionality with the input sequence.

The output of the attention mechanism 112 can be provided to a feed forward (FF) layer 114. The structure of the FF layer 114 can be or can include any suitable FF layer for a transformer model. One example FF layer 114 includes a multilayer perceptron (MLP) layer that includes linear transformations and/or activation functions. The linear transformations can increase or decrease dimensionality of the input. As one example, the MLP layer can include a first linear transformation that increases a dimensionality of the input to an intermediate representation and a second linear transformation that reduces the dimensionality of the intermediate representation back to the dimensionality of the input. In some implementations, unlike the attention mechanism, the linear transformations may map a token from one representation to another independently.

If the transformer model 100 includes multiple transformer blocks 110, the output of the FF layer 114 of one transformer block 110 can be provided as input to the (e.g., attention mechanism 112 of the) subsequent transformer block 110. Furthermore, in some implementations, the transformer model 100 can include a prediction layer 116. For instance, the prediction layer 116 can be a final layer of the transformer model 100. The prediction layer 116 can project the output of the FF layer 114 (e.g., of the final transformer block 110) to a prediction space. The dimensionality of the prediction space can be based on the vocabulary of the transformer model 100. For example, in some implementations, the projection into the prediction space generates a probability tensor 118 having a unique probability value (which may be referred to as a logit) for each candidate token in the vocabulary of the transformer model 100. In some implementations, the probability tensor 118 is normalized (e.g., by a SoftMax function) such that the probability tensor 118 represents a probability distribution that sums to a constant value (e.g., one). A maximum (or, in some configurations, a minimum or other optimum value) value within the probability tensor 118 can therefore correspond to a most likely token in the sequence. One or more tokens can therefore be sampled with respect to the probability distribution defined by the probability tensor 118. The sampled token(s) can be output as output tokens 120 from the transformer model 100. This process can be repeated to form an output sequence including a plurality of tokens.

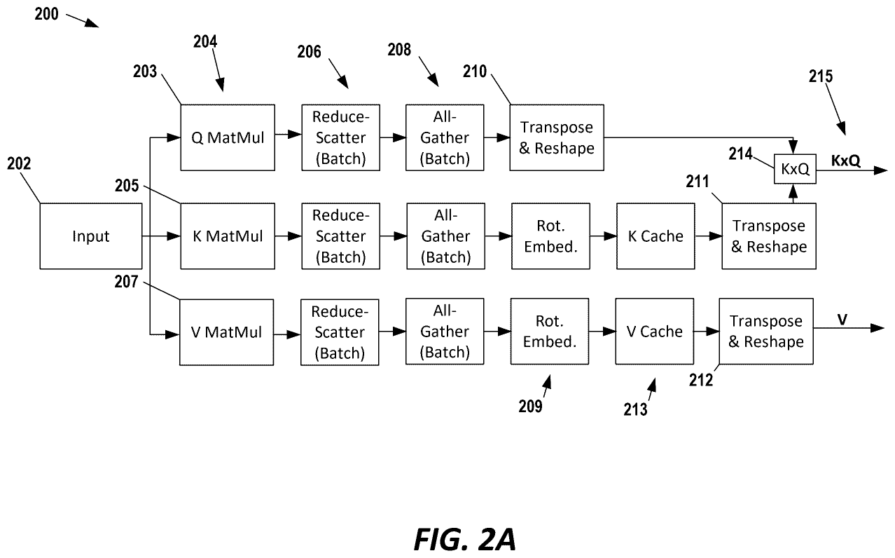

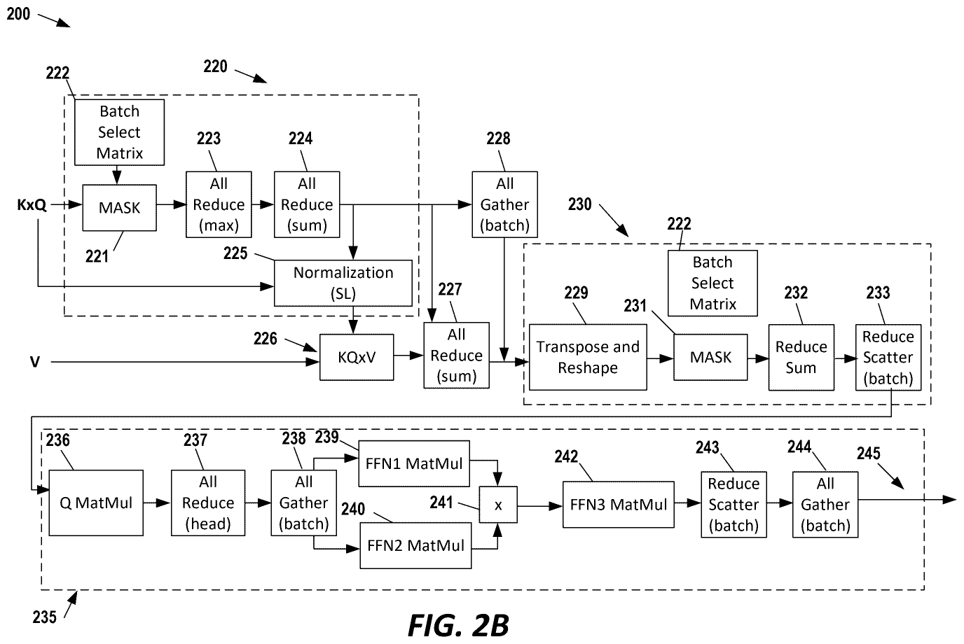

FIG. 2A depicts a diagram of a portion of a transformer 200 according to example aspects of the present disclosure. The portion of the transformer 200 depicted in FIG. 2A can be, for example, a portion of an attention mechanism of the transformer 200. The transformer 200 can be, in some implementations, the transformer 100 of FIG. 1.

A system implementing the transformer 200 can receive and provide input 202 (or “input data”) to the transformer 200. For instance, the transformer 200 can receive or otherwise obtain the input 202. The input 202 is represented in FIG. 2A as a tensor comprising a batch dimension B, a token dimension T, and a context or sequence length SL. One example sequence length is 8192 tokens, although it should be understood that any suitable sequence length may be employed without departing from the scope of the present disclosure, such as a sequence length that is a multiple of two.

In some implementations, portions of the input 202 may be associated with batches respectively corresponding to different users or generation tasks. For example, a first portion of the input data may correspond to a first batch and a second portion of the input data may correspond to a second batch, where both batches are processed concurrently (e.g., along with other batches) through the transformer 200. The transformer 200 can therefore, in some implementations, obtain first input data respective to a first generation task and obtain second input data respective to a second generation task. The batches may include a number of tokens that is some factor of the sequence length of the transformer 200. For example, if the sequence length is 8192 tokens and there are four batches per sequence length and processing instance, the batches may include 2048 tokens. The first input data and the second input data can be provided to an attention mechanism of the transformer model 200 to generate a shared context (e.g., including data associated with a plurality of batches) based on the first input data and the second input data.

The transformer 200 can include projection operations 204 that project the input 202 into vectors for attention processing. Example vectors include a query vector, a key vector, and a value vector. In the example of FIG. 2A, the projection operations 204 include a first matrix multiplication (MatMul) operation 203 or Q MatMul 203 to project the input 202 to a query tensor Q. The Q MatMul 203 can employ a learned query weight matrix having dimensions of the sequence length (e.g., 8192) by a query head dimension h. Additionally and/or alternatively, the Q MatMul operation can utilize a two-dimensional weight matrix W with each dimension being equal to the sequence length (e.g., 8192×8192) to transform the input activations into the query space. For example, the head dimension can be equal to the sequence length. Additionally and/or alternatively, the projection operations 204 can include a second MatMul operation 205, or K MatMul 205, to generate a key tensor K. The K MatMul 205 can employ a learned key weight matrix having dimensions of the sequence length and a key head dimension (e.g., 8192×1024). Additionally and/or alternatively, the projection operations 204 can include a third MatMul operation 207, or V MatMul 207, to generate a value tensor V. The V MatMul 207 can employ a learned value weight matrix having dimensions of the sequence length and a value head dimension (e.g., 8192×1024).

The matrix multiplications 203, 205, and 207 can be followed by Reduce-Scatter operations 206 and All-Gather operations 208 which reshape the dimensions of the Q, K, and V vectors for consistent processing. The Reduce-Scatter operations 206 can reduce data across functional units while scattering results to facilitate parallel computation. The All-Gather operations 208 provide for collecting data from across the processing array to provide that all heads have access to the query information. Example Reduce-Scatter operations 206 and All-Gather operations 208 can be implemented using example libraries, such as, for example, the TensorFlow libraries (e.g., tf.scatter; tf.gather). Furthermore, a Rotary Embedding operation 209 can follow the All-Gather operations 208 for the K and V tensors. The Rotary Embedding operation 209 can encode relative positional information directly into respective tensors.

In the example of FIG. 2A, the K and V tensors can be cached in a key-value cache (KV cache) at 213 and loaded in subsequent processing operations. During an initial pass through the transformer 200, or when the key-value cache lacks data for a particular key-value pair, the processing can involve generating the K and V tensors by the operations 205-209. On subsequent passes, however, the K and V tensors may not change as the tensors are not query-dependent. Thus, once the computation is completed for one query, the K and V tensors can be reutilized for subsequent queries so long as the tensors persist in the KV cache. Although often beneficial, it should be understood that in some implementations the KV cache may be omitted and the tensors may be computed from scratch at each processing instance.

The flow can additionally include Transpose and Reshape operations 210, 211 and 212 that respectively organize the key, value, and query tensors into dimensions that are suitable for downstream processing. As one example, the Transpose and Reshape operation 210 can reformat the query tensor into dimensionality of [B, 64, T, 128]. As another example, the Transpose and Reshape operation 211 can reformat the key tensor into dimensionality of [B, 8, 128, SL]. As another example, the Transpose and Reshape operation 212 can reformat the value tensor into dimensionality of [B, 8, SL, 128]. While these dimensions are chosen to facilitate semantically proper tensor multiplication in the example transformer 200 of FIGS. 2A-2B, it should be understood that variations in the transformer 200 can involve modifications to the dimensionality of the tensors described herein, and such variations are expressly contemplated as being within the scope of the present disclosure.

The K and Q tensors can be multiplied at 214 to generate a similarity matrix (referred to as K×Q for the purposes of illustration) that represents the raw attention scores between the query and key pairs across the SL and T dimensions. The output 215 of FIG. 2A thus includes the K×Q similarity matrix and the V tensor.

FIG. 2B depicts a logic diagram of a second portion of the transformer 200 continuing from the K×Q similarity matrix and V tensor from FIG. 2A. The transformer 200 can include a batch folded normalization operation at 220. The batch folded normalization operation involves batching the shared context (e.g., represented by the K, Q, and V tensors) to produce a first batch associated with the first input data and a second batch associated with the second input data, where the batches are processed without affecting the values of tokens generated for other batches. To accomplish this, a Mask operation 221 is used to mask portions of the shared context corresponding to other batches while processing data for one batch. In some implementations, batching the shared context comprises generating a batch select matrix 222 comprising data representative of whether a respective batch of the first batch or the second batch will be masked. The batch select matrix 222, when combined with the Mask operation 221, provides for selectively folding multiple portions of the shared context, including disjoint portions, into a single batch. For example, the batch select matrix 222 can be a [B, B, 1, 1] tensor where values of the first and second dimension take on one values or zero values such that, when the batch select matrix 222 is multiplied by the shared context, the multiplication by one values preserves the values of selected batches, and the multiplication by zero values negates any contribution from non-selected batches. Because the batch select matrix 222 is of B length, disjoint portions (e.g., corresponding to a first and third, first and fourth, second and fourth, etc.) can be folded into a single processing instance or batch, even when not sequentially positioned within the shared context. This can provide for utilizing first-available context space without forcing a computing system to wait for sequential context space for contexts larger than a batch, which can improve processing speeds, especially in cases of multiple users. The Mask operation 221 utilizes the batch select matrix 222 in generating a mask to be applied to the attention scores to effectively isolate user-specific data and prevent cross-contamination between folded batches. This can be, for example, performing a first operation on the first batch while masking a portion of the shared context corresponding to the second batch. The first operation can be, for example, a normalization (e.g., SoftMax) operation, and masking the portion of the shared context can include multiplying the batch select matrix by the shared context.

The batch folded normalization operation 220 further involves an All-Reduce (Max) operation 223 and an All-Reduce (Sum) operation 224, which are dependent on sequence length. The All-Reduce (Max) operation 223 can involve identifying the largest value in the masked context to ensure numerical stability during exponentiation. For instance, the All-Reduce (Max) operation 223 can be implemented using a ReduceMax algorithm, such as tensorflow.math.reduce_max( ) of the TensorFlow Python library, to provide for identifying a maximum value of elements across dimensions of a tensor. The All-Reduce (Sum) operation 224 can involve calculating the denominator for the normalization across the active sequence length. Additionally and/or alternatively, the All-Reduce (Sum) operation 224 can be implemented using a ReduceSum operation, such as tensorflow.math.reduce_sum( ) of the TensorFlow Python library, to provide for identifying a sum of elements across dimensions of a tensor. Finally, a normalization operation 225 can be performed on the masked shared context over the sequence length. This final normalization operation 225 can convert the raw attention scores into a normalized probability distribution representing the attention weights.

By masking the K×Q tensor at this batched operation, the present disclosure can provide for reduced computational resource use at those operations. For instance, the normalization operation 225 can now reduce over only the masked sequence length (e.g., one batch, or a plurality of folded batches less than a total sequence length) rather than the entire sequence length of the context. This, in turn, can provide for reduced cost of operating the transformer 200 and/or improved generation speeds.

At 226, the output of the normalization operation 225 (based on the K×Q tensor) is multiplied by the V tensor to generate attention scores, combining the normalized attention weights with the value representations to produce a weighted context tensor (referred to as the KQ×V tensor for the purposes of illustration). The resulting tensor is then processed by an All-Reduce operation 227 over the sequence length to aggregate information across heads. Thus, the transformer 200 can generate data indicative of attention scores based on an output of the normalization operation 225. Generating the data indicative of the attention scores can further include performing a second operation on the first batch while masking a portion of the shared context corresponding to the second batch. For instance, the second operation can include determining a dot product of the shared context while masking the portion of the shared context corresponding to the second batch. This operation can include performing a dot product over the entire sequence length, including portions of the sequence length allocated to other batches and/or other users. Therefore, it can be similarly beneficial to mask the result of this operation. In parallel, an All-Gather operation 228 can be performed on the output of the All-Reduce (Sum) operation 224.

Subsequent to performing the first operation on the first batch, the logic is configured for transposing and reshaping an output of the first operation to remap the output of the first operation to a dimensionality of input to the attention mechanism, the input to the attention mechanism comprising the first input data and the second input data. For instance, the Transpose and Reshape operations 229 provide for reshaping and masking the KQ×V tensor to produce a context that is consistent with the remaining architecture of the transformer model 200, including attention output stages 230. For instance, the Transpose and Reshape operations 229 transform the attention output back into a dimensionality of [B, T, SL] to match the feature space of the input 202. A subsequent Mask operation 231 applies a secondary mask based on the batch select matrix 222 to enforce the folded batch boundaries. A ReduceSum operation 232 can provide for compressing the masked KQ×V tensor across the batch folding dimensions. Finally, a Reduce-Scatter operation 233 over the batch folding dimensions can prepare the finalized attention output for the feed-forward stages of the transformer 200. For instance, the operations from 235 onward can represent a feed-forward (FF) layer of the transformer model 200. Generally, it can be desirable to reduce and/or reshape the context before the transition to the FF layer at 235 for consistent processing.

The feed-forward layer 235 includes an O MatMul operation 236 that utilizes a weight matrix W to project the attention output. This is followed by an All-Reduce operation 237 over the head dimension and an All-Gather operation 238 over the batch dimension to synchronize the projected activations across the transformer 200. A first feed-forward network (FFN1) MatMul operation 239 and a second feed-forward network (FFN2) MatMul operation 240 are then performed to compute parallel transformations using large weight matrices, such as weight matrices having dimensions of [8192, 28672]. For example, the dimensions of the weight matrices can be based on the sequence length of the context. It should be understood that parameters (e.g., weights) of these weight matrices, as well as the other matrices described herein, can have values that are learned through a variety of refinement processes referred to as training of the transformer 200. These parallel outputs can be combined at a gating multiplication operation 241 before being provided to a third feed-forward network (FFN3) MatMul operation 242. The FFN3 MatMul 242 projects the intermediate representations back to the hidden dimension of the sequence length. The feed-forward layer 235 can conclude with a final Reduce-Scatter operation 243 over the batch and an All-Gather operation 244 over the head dimension to distribute the resulting tokens as output 245 to subsequent transformer processing operations (e.g., subsequent transformer blocks or a prediction layer).

Example aspects of the present disclosure may be implemented using one or more processors or other processing circuitry, such as tensor streaming processors (TSPs), field programmable gate arrays (FPGAs), application-specific integrated circuits (ASICs), graphics processing units (GPUs), central processing units (CPUs), language processing units (LPUs), etc. An example tensor streaming processor will be discussed in detail below for purposes of illustration and discussion. However, those of ordinary skill in the art, using the disclosures provided herein, will understand that aspects of the present disclosure may be implemented using any suitable processor, processing circuitry, or the like without deviating from the scope of the present disclosure.

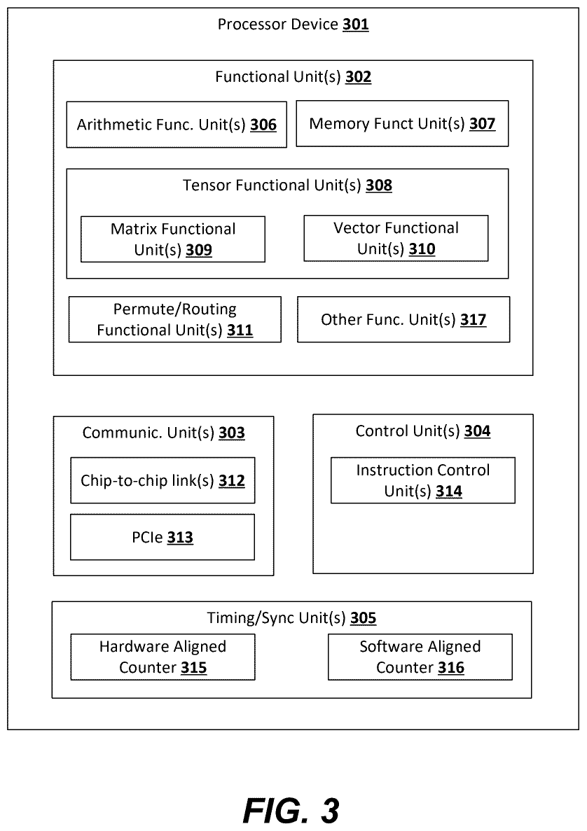

FIG. 3 is a block diagram of an example processor device 301 according to example implementations of aspects of the present disclosure. The processor device 301 can include one or more functional units 302; one or more communication units 303; one or more control units 304 (e.g., instruction control unit(s) 314, etc.); one or more timing or synchronization units 305; or other components. In some instances, functional unit(s) 302 of the processor device 301 can include one or more of: arithmetic functional unit(s) 306; memory functional unit(s) 307; tensor functional unit(s) 308 (e.g., matrix functional unit(s) 309, vector functional unit(s) 310, etc.), permute or routing functional units 311, or other functional units 317. Communication unit(s) 303 can include, for example, one or more of chip-to-chip communication link(s) 312, peripheral component interconnect express 313 components, or other communication unit(s) 303. Timing and synchronization units 305 can include, for example, one or more hardware-aligned counters 315, one or more software-aligned counters 316, or other timing or synchronization component.

A processor device 301 can include various types of processor architectures. In some instances, a processor device 301 can include a single-core or multi-core processor device 301. In some instances, a processor device 301 can include an integrated circuit located on a single die or a processor device 301 distributed over multiple dies connected together (e.g., directly connected such as via face-to-face connection, indirectly connected such as via one or more interposers, etc.). In some instances, a processor device 301 can include one or more of: one or more field-programmable gate arrays (FPGAs); one or more application-specific integrated circuits (ASICs), such as ASICs for machine-learned inference, matrix multiplication, floating-point operations, or the like; one or more graphics processor units (GPUs); one or more tensor processing devices; or other processor type. In some instances, a processor device 301 can include a deterministic processor device or a non-deterministic processor device (e.g., processor device configured to operate according to a deterministic or non-deterministic timing, etc.). In some instances, a processor device 301 can include a processor device having a plurality of dedicated special-purpose functional units, or a processor device having one or more general-purpose functional units (e.g., multi-core processor having a plurality of general-purpose processor cores, etc.). For example, in some instances, a processor device 301 can include a single-core processor device 301 having a plurality of special-purpose functional units 302 having distinct functions, such as functional units 302 having distinct instruction set architectures.

In some instances, a processor device 301 can include a deterministic processor device. A deterministic processor device can include, for example, a processor device configured to perform a plurality of operations according to a predetermined order, such as a predetermined program order defined by a compiler. In some instances, a deterministic processor device can include a processor device configured to perform a plurality of operations according to a predetermined timing or according to a predetermined temporal relationship between operations. For example, in some instances, a deterministic processor can include a processor configured to receive one or more computer-executable instructions (e.g., compiled instructions, etc.) comprising timing data; and execute the instruction(s) according to a predetermined time or predetermined temporal relationship indicated by the timing data. Timing data can include, for example, one or more of: data indicative of a clock cycle on which to execute a particular operation; data indicative of a temporal relationship between one or more first operations and one or more second operations, such as data indicative of a number of clock cycles to pause after a first operation (e.g., data transfer operation, instruction transfer operation, floating-point operation, etc.) is completed before performing a second operation (e.g., floating-point operation, tensor processing operation, etc.); data indicative of one or more operations or instructions configured to have an effect on a timing of operations, such as data indicative of one or more no-operation (NOP) operations or sleep operations, such as a repeated-NOP instruction to cause a functional unit 302 or other component of a processor device 301 to remain idle for a predetermined number of clock cycles; or other timing data.

In some instances, a deterministic processor device can include a processor device configured to receive, from a compiler, a set of computer-executable instructions controlling a timing of a plurality of operations associated with the computer-executable instructions; and perform the plurality of operations according to the timing. For example, in some instances, a deterministic processor device can include a processor device configured to receive a compiled program configured to cause, for each respective operation of a plurality of operations (e.g., arithmetic operations such as floating-point operations, tensor operations, etc.) to be performed on one or more respective data operands (e.g., numerical operands such as machine-learned model parameters, activation values, etc.), an instruction associated with the respective operation to intersect with the respective data operand at a predetermined time instant (e.g., clock cycle, clock cycle offset relative to an initial clock cycle, etc.) defined in the compiled program. In some instances, a deterministic processor can include a processor device having one or more components (e.g., functional unit(s) 302, communication unit(s) 303, etc.) having an instruction set architecture comprising instructions to control a timing of one or more operations of the one or more components.

In some instances, a deterministic processor device 301 can include a processor device configured to route data between functional units 302 of the processor device 301 according to a predetermined timing, predetermined routing or pathing, or both. For example, in some instances, a deterministic processor device 301 can include a processor device configured to receive compiled instructions comprising data indicative of one or more data transfers operations to be performed according to one or more predetermined routes determined by a compiler, according to one or more predetermined timing values defined by the compiler, or both. In this manner, for instance, a deterministic processor device 301 can enable a compiler to perform compile-time load balancing for a plurality of data paths, and can execute a plurality of runtime data transfers according to the compile-time load balancing.

In some instances, a deterministic processor device 301 can include a processor that lacks one or more non-deterministic components that may be commonplace among non-deterministic processor devices, such as branch prediction units, tiered or hierarchical cache devices, runtime load balancing, or other sources of runtime non-determinism (e.g., non-deterministic timing of operations, non-deterministic choice of operations such as non-deterministic routing of data, etc.). For example, in some instances, a processor device 301 can lack any branch prediction components, and can be configured to execute every operation of a compiled program according to a predetermined program order. As another example, in some instances, one or more memory functional units 307 can lack a cache hierarchy or lack any non-deterministic memory component(s). For example, in some instances, one or more memory functional units 307 can be configured to operate deterministically, such as according to a predetermined timing defined by a compiler. For example, in some instances, one or more memory functional units 307 can be configured to perform one or more read operations at one or more times predetermined by a compiler; perform one or more write operations at one or more times predetermined by the compiler; perform one or more refresh operations at one or more times predetermined by the compiler, such that the compiler can have explicit control over a refresh timing of the memory functional unit(s) 307; or the like. For example, in some instances, the compiler can compile a program or other executable into a set of deterministic operations that can be executed by the functional unit(s) 302 at known times specified by a deterministic schedule.

However, although a deterministic processor device 301 can lack some common sources of non-determinism, in some instances, a deterministic processor device 301 can include or interact with one or more non-deterministic components or devices without deviating from the scope of the present disclosure. As a non-limiting illustrative example, in some instances, a deterministic processor device 301 can include a PCIe 313 component configured to perform external input/output (I/O) operations, which can in some instances include input/output operations having a non-deterministic timing (e.g., I/O operations using a non-deterministic PCIe 313 device; I/O operations receiving input from non-deterministic external device(s); etc.). In some instances, a deterministic processor device 301 can interact with non-deterministic component(s) or device(s) (e.g., components or devices internal or external to the processor, etc.), while maintaining deterministic operation of the remaining components of the processor device 301 by designating one or more predetermined time windows to interact with the non-deterministic component(s) in a deterministic manner. For example, in some instances, a processor device 301 can be configured to check, at each of a plurality of predetermined times, whether one or more inputs (e.g., inference request(s), etc.) have been received via a PCIe device 313; and, if the processor device 301 determines that an input has been received, to process the input (e.g., write the input to a designated memory location or region, etc.) according to a predetermined timing or predetermined set of instructions (e.g., according to a set of operations configured to fit within a predetermined time window reserved for non-deterministic external I/O operations, etc.).

In some instances, a processor device 301 can include a processor device configured for single-instruction multiple-data (SIMD) operation. For example, in some instances, a processor device 301 can be configured to receive one or more computer-executable instructions that are each indicative of an operation to be performed on a plurality of operands, such as a vector of numerical operands; a tensor of numerical operands; or the like. In some instances, a SIMD processor device can include a processor device configured to provide a single instruction to a plurality of functional units 302 (e.g., adjacent functional units 302 arranged in a functional region, etc.) to cause each respective functional unit 302 of the plurality of functional units 302 to execute the instruction on one or more distinct operands provided to the respective functional unit 302 (e.g., routed to the respective functional unit 302 according to a predetermined compiler-defined routing, etc.).

In some instances, a processor device 301 can include a single-core processor device, or a processor device configured to operate as a single-core device (e.g., flexible-operation processor device having two hemispheres that can be operated in series as a single-core device or in parallel as a multi-core device, etc.). For example, in some instances, a single-core processor device can include a processor device configured to receive a single set of instructions (e.g., compiled instructions, etc.) and to execute, in a serial or pipelined fashion using one or more functional units 302, a set of operations defined by the single set of instructions. For example, in some instances, a single-core processor device 301 can include a processor device configured to obtain (e.g., receive, retrieve, etc.) one or more instructions (e.g., SIMD instructions, etc.) indicative of a plurality of operations (e.g., plurality of SIMD operations, etc.) to be performed on one or more operands; and perform, in series using a plurality of functional units 302, the plurality of operations (e.g., SIMD operations wherein each operation is a multiple-data operation, etc.) on the one or more operands.

Functional unit(s) 302 can include, for example, one or more components (e.g., integrated circuit components, etc.) configured to perform operations on one or more operands (e.g., data operands, etc.). In some instances, functional unit(s) 302 can include deterministic functional units 302, such as deterministic functional units configured to perform one or more operations in a predetermined program order, according to a predetermined timing or temporal relationship, or the like. In some instances, a set of functional units 302 can include a plurality of dedicated or special-purpose functional units 302, such as distinct functional units 302 having distinct functions or sets of functions (e.g., limited or specialized function sets, etc.). In some instances, functional unit(s) 302 can include functional units configured to perform multiple operations per instruction for at least some instructions, such as single-instruction multiple-data (SIMD) functional unit(s) 302, and/or functional unit(s) 302 configured to process instruction(s) directed to multiple computing operations (e.g., multiple repetitions of a single type of operation, pipeline of multiple different operations, etc.).

In some instances, a set of dedicated functional unit(s) 302 can include distinct dedicated functional units 302 for each of a plurality of steps in a machine-learned inference pipeline, such as a distinct dedicated functional unit for each component of a category or type of machine-learned model layer (e.g., convolutional layer, attention layer, fully connected layer, etc.). For example, in some instances, a set of dedicated functional units 302 for implementing a fully connected layer of a machine-learned model can include one or more matrix functional units 309 for performing matrix multiplication between a parameter tensor (e.g., weight matrix, etc.) and a tensor (e.g., vector, etc.) of input values to the fully connected layer, and one or more vector functional units 310 for performing an activation function of the fully connected layer. As another example, in some instances, a set of dedicated functional units 302 for implementing a convolutional layer of a machine-learned model can include one or more permute/routing functional units 311 configured to perform one or more data reshaping operations corresponding to one or more convolutions (e.g., two-dimensional convolutions, one-dimensional convolutions, etc.); and one or more other functional units 302 (e.g., matrix functional unit(s) 309, vector functional unit(s) 310, etc.) for performing additional operations associated with a convolutional layer or convolutional neural network (e.g., matrix multiplication, pooling, activation functions, etc.).

In some instances, a plurality of dedicated functional units 302 can include a first functional unit 302 configured to perform a set of operations that is different (e.g., completely disjoint from or partially overlapping, etc.) from a second set of operations associated with a second functional unit 302. In some instances, a plurality of special-purpose or dedicated functional units 302 can have a plurality of distinct instruction set architectures, such as limited or special-purpose instruction set architectures each supporting a limited or special-purpose set of operations. As a non-limiting illustrative example, in some instances, a set of dedicated functional units 302 can include one or more of: a matrix functional unit 309 configured to perform a first set of matrix operations (e.g., matrix multiplication operations, etc.); a vector functional unit 310 configured to perform a set of vector operations different from the matrix operations (e.g., activation function operations such as rectified linear unit (ReLU), sigmoidal, SoftMax, or other activation function operations; normalization operations; etc.); a permute/routing functional unit 311 configured to perform one or more data routing, data permutation, or data reshaping functions (e.g., tensor permutation or reshaping, etc.) different from the matrix operation(s) and different from the vector operation(s); or other dedicated functional unit(s) 302. Other examples are possible.

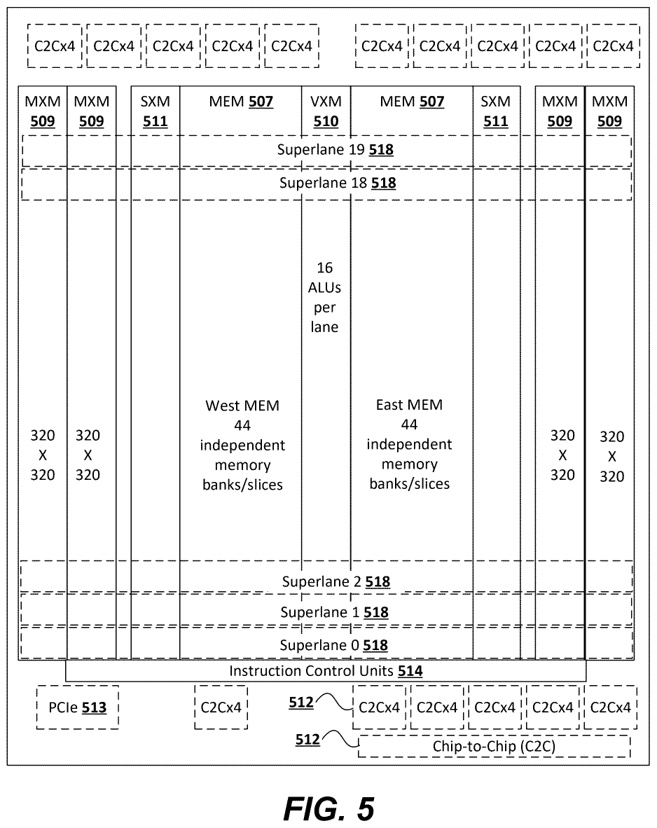

In some instances, functional unit(s) 302 can include functional units organized into functional regions of a processor die, such as compact functional regions configured to facilitate low-latency propagation of instructions or operands within a functional unit 302 or between adjacent functional units 302. As a non-limiting illustrative example, in some instances, one or more functional units 302 can be organized into functional slices along a first axis of a processor die, thereby enabling low-latency propagation of one or more instructions along the axis, low-latency propagation of operand data along a second axis, or the like. Further details of an example processor device comprising functional slices are provided below with respect to FIG. 5.

In some instances, functional unit(s) 302 or functional region(s) can be geographically organized on a processor die to reduce (e.g., minimize or nearly minimize; reduce relative to a random arrangement or relative to a conventional multi-core central processing unit or conventional graphics processing unit, etc.) a communication cost (e.g., latency cost, power cost, communication distance, etc.) associated with one or more computational pipelines, such as machine-learned inference pipelines. For example, in some instances, one or more functional units 302 or functional regions of a processor device 301 for performing a sequentially first operation in a computational pipeline can be geographically close to one or more functional units 302 for performing a sequentially second operation in the computational pipeline. Example computational pipelines can include, for example, inference pipelines associated with common machine-learned model, layer, or head architectures, such as convolutional architectures; attention architectures; fully connected layer architectures; selective structured state space machine architectures; gating architectures (e.g., long short-term memory, etc.); or another machine learning architecture.

In some instances, functional unit(s) 302 can include functional units configured to perform multiple operations per instruction for at least some instructions, such as single-instruction multiple-data (SIMD) functional unit(s) 302 or functional units 302 configured to operate without necessarily receiving explicit instructions for each operation. For example, functional unit(s) 302 configured to operate without necessarily receiving explicit instructions for each operation can include one or more of: functional unit(s) 302 configured to receive intermittent instructions and perform multiple operations per instruction (e.g., repeated single operation, pipeline of multiple different operations, etc.); functional unit(s) 302 configured to operate without instructions according to a default operation; or the like. In this manner, for instance, an amount of communication required to provide instructions to the functional units 302 can be reduced, and operation of the processor device 301 can in some instances be simplified compared to some alternative implementations.

For example, in some instances, a SIMD functional unit 302 can include a tensor functional unit 308 configured to execute an instruction on a plurality of numerical values, such as a vector or matrix of numerical values. For example, in some instances, a tensor functional unit 308 can be configured to receive an instruction; and process, according to the instruction, a tensor (e.g., one-dimensional vector tensor, two-dimensional matrix tensor, etc.) comprising a plurality of numerical values (e.g., dozens of numerical values per instruction, such as hundreds, such as 320 numerical values in some examples described below with respect to FIG. 5). In some instances, a tensor functional unit 308 can be configured to process some or all of a plurality of values simultaneously, or to execute a single-instruction multiple-data instruction according to a staggered timing.

As another example, in some instances, a functional unit 302 configured to operate based on intermittent instructions can include a functional unit 302 configured to repeat one or more operations, such as a functional unit 302 configured to continue performing a given operation (e.g., an operation associated with a most recently received instruction, etc.) periodically (e.g., at every clock cycle; at every Nth clock cycle; etc.) for some amount of time (e.g., indefinitely, for a finite period of time such as a time period defined by a previously received instruction, etc.) in the absence of explicit instructions. In some instances, a functional unit 302 can include a functional unit 302 configured to receive and execute one or more repetition instructions (e.g., having an instruction set architecture comprising one or more repetition instructions, etc.). A repetition instruction can include, for example, an instruction to cause the functional unit 302 to repeat (e.g., repeat at every clock cycle; at every Nth clock cycle, where N can be a parameter of the instruction; etc.) a previous instruction or set of instructions a number of times specified by the instruction; an instruction indicative of an operation to be repeated (e.g., arithmetic operation, matrix operation, vector operation, etc.), the instruction having a repetition parameter indicating a number of times to repeat the operation; or the like. In some instances, a repetition instruction can include one or more offset parameters, such as a time offset parameter (e.g., number of cycles to wait between repetitions, etc.), location offset parameter indicative of a distance between consecutive locations (e.g., functional unit 302 location, memory location, data path location, etc.) associated with a repeated operation, or other offset parameter.

As another example, in some instances, a functional unit 302 can include a functional unit 302 configured to receive a single instruction indicative of multiple distinct operations to be performed on a single operand or set of operands, such as a multiply-accumulate (MACC) instruction or matrix multiplication instruction indicative of one or more multiply operations and one or more accumulate operations to be performed on one or more outputs of the multiply operation(s). In some instances, a functional unit 302 can include a pipelined hardware architecture (e.g., systolic array pipelined hardware, deterministic streaming hardware such as hardware having one or more properties described with respect to FIG. 5, etc.) configured to provide (e.g., directly; indirectly via one or more buffers, registers, or other memory components; etc.) an output of one or more first hardware devices (e.g., floating-point units, etc.) for performing earlier (e.g., sequentially first, etc.) operations of a multi-operation instruction to an input of one or more second hardware devices for performing later (e.g., sequentially second or last, etc.) operations of the multi-operation instruction. In some instances, a pipelined hardware architecture of a functional unit 302 can include a geographically compact architecture, wherein a plurality of components for performing a multi-operation instruction can be adjacent or otherwise close together on a processor die.

An arithmetic functional unit 306 can include, for example, one or more functional units 302 for performing various arithmetic operations, such as floating-point operations, integer operations, or quantized operations; simple operations (e.g., add, multiply, format conversion, etc.) or complex/combined operations (e.g., multiply-accumulate, etc.); single-operand operations or multi-operand operations (e.g., tensor operations, etc.); or other arithmetic operations. In some instances, an arithmetic functional unit 306 can be a tensor functional unit 308 or component thereof, or have one or more properties described below with respect to tensor functional unit(s) 308.

A memory functional unit 307 can include, for example, one or more functional units 302 for reading, writing, or storing various kinds of data, such as operand data, instruction data, or other data. Data storage can include, for example, temporary storage of one-time-use or ephemeral values (e.g., computed operand values, etc.), longer-term storage of values to be reused (e.g., machine-learned model weights, compiled computer-executable instructions, etc.), or other storage. In some instances, a memory functional unit 307 can include one or more low-latency, high-bandwidth, or otherwise rapidly accessible memory devices, such as random access memory (RAM) devices (e.g., static random access memory (SRAM), high-bandwidth memory (HBM), dynamic random access memory (DRAM), etc.), registers, or other low-latency devices.

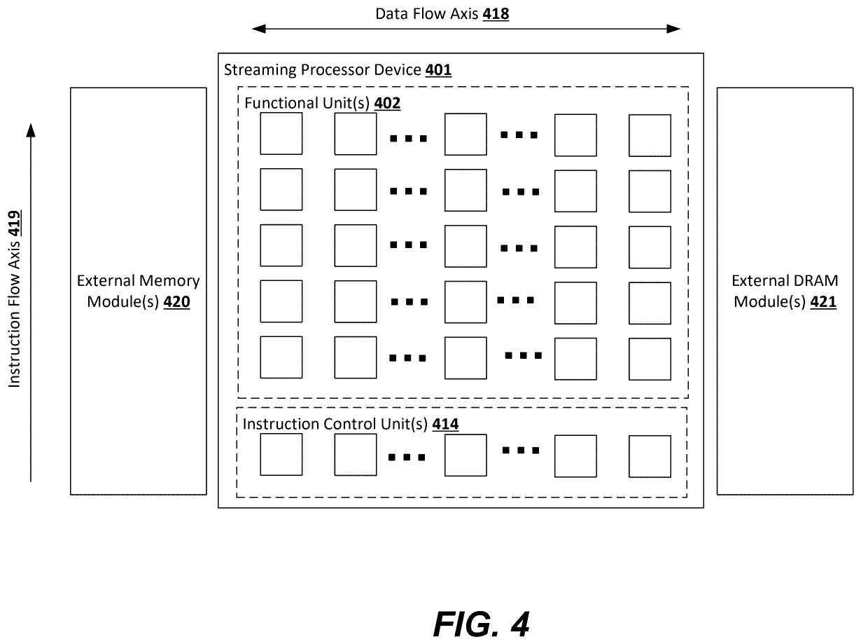

In some instances, one or more memory functional units 307 can be configured to share a global address space accessible to a plurality of functional units 302. For example, in some instances, a global address space can include all memory locations available to the processor device 301 (e.g., including any external memory modules, etc.), such that any functional unit 302 of the processor device 301 can obtain (e.g., receive at a predetermined time defined by the compiler, such as without requiring the functional unit 302 to output any request for the data obtained). In some instances, a set of memory functional unit(s) 307 can include, or a processor device 301 can have access to, one or more internal (e.g., on-chip) memory functional units 307; one or more external (e.g., off-chip, near-compute, etc.) memory units; or both. Further details of some example near-compute external memory units are provided below with respect to FIG. 4, while details of some example on-chip memory units are provided below with respect to FIG. 5.

A tensor processing unit 308 can include, for example, a functional unit 302 to perform one or more operations (e.g., arithmetic operations such as tensor multiplication, elementwise multiplication, normalization, activation function operations, etc.) on one or more tensors (e.g., matrices, vectors, etc.). In some instances, a tensor processing unit 308 can include a matrix functional unit 309; a vector functional unit 310; or another functional unit.

A matrix processing unit 309 can include, for example, a functional unit 302 configured to perform one or more operations on a matrix (e.g., two-dimensional matrix, flattened matrix, etc.) of operands (e.g., numerical values such as floating-point values, etc.). In some instances, a matrix processing unit 309 can include a functional unit 302 configured to perform matrix multiplication or other matrix operations.

A vector processing unit 310 can include, for example, a functional unit 302 configured to perform one or more operations on a vector (e.g., one-dimensional vector, flattened tensor, etc.) of operands (e.g., floating-point numerical values, etc.). In some instances, a vector processing unit 310 can include a functional unit 302 configured to perform one or more of: one or more activation function operations (e.g., sigmoidal or logistic activation function, linear unit activation function such as rectified linear unit (ReLU), SoftMax activation function, etc.), one or more normalization operations (e.g., L2 normalization, etc.), one or more combining operations (e.g., attention-based combining, etc.) to combine a set (e.g., pair, trio, etc.) of vectors, one or more constituent operations configured to be combined to support a class of related operations (e.g., class or category of normalization operations, class or category of activation function operations, etc.), or the like.

A permute/routing functional unit 311 can include, for example, a functional unit 302 configured to perform one or more data permuting or data routing operations. In some instances, a data permuting operation can include one or more swap or reordering operations configured to reorder data in an ordered format (e.g., vector format or other tensor format; ordered arrangement of registers, signal lines, or other hardware units; etc.), such as without changing a shape (e.g., length, width, number of dimensions, etc.) of the ordered format. Example reordering operations can include, for example, rotation or translation operations; arbitrary reordering operations defined by one or more reordering maps such as a gather map; or other reordering operations. In some instances, a data permuting operation can include a reshaping operation, such as a reshaping operation changing a number of dimensions of a data structure (e.g., tensor, hardware devices corresponding to a tensor, etc.), changing a size of one or more dimensions of the data structure, or the like. As a non-limiting illustrative example, in some instances, a reshaping operation can include a tensor flattening operation to convert a multi-dimensional tensor into a one-dimensional data structure (e.g., vector, hardware configuration corresponding to a vector, one-dimensional data stream corresponding to a vector, etc.). As another example, in some instances, a reshaping operation can include an expansion or duplication operation, such as a reshaping operation to generate an expanded convolutional kernel to implement a filter component of a convolutional neural network. In some instances, a routing operation can include a permuting operation to change an ordering of operands input to one or more fixed or predetermined data paths, or another routing operation (e.g., switching operation; pair of operations comprising a send and a receive; etc.). In some instances, a permuting operation can include a routing operation to change a routing of operands to hardware having a fixed or predetermined input order.

In some instances, a memory functional unit 307; a tensor, matrix, or vector functional unit 308, 309, 310; or a permute/routing functional unit 311 can be or include a deterministic functional unit 302 configured to execute instruction(s) at a predetermined time defined by a compiler; a single-instruction multiple-operation functional unit 302 configured to perform a plurality of operations based on one instruction; or have any other property described herein with respect to functional unit(s) 302. Further details of some example functional units 307, 309, 310, 311 are provided below with respect to FIG. 5.

Communication units 303 can include various components for performing communication operations (e.g., input, output, etc.) between the processor device 301 and other devices (e.g., processor devices, computing devices, external memory devices, etc.) or components, or within the processor device 301. In some instances, communication units 303 can include deterministic communication units (e.g., communication units performing operations according to a predetermined program order, timing, temporal relationship, or other predetermined property, etc.), non-deterministic communication units (e.g., communication units having non-deterministic timing properties, communication units configured to communicate with non-deterministic external devices, etc.), or both. For example, in some instances, a deterministic processor device 301 can include a plurality of deterministic chip-to-chip communication links 312 configured to communicate with other deterministic processor devices 301 (e.g., using deterministic communication operations having a predetermined timing, communication path, or other property), along with one or more PCIe components 313 configured to interact with one or more non-deterministic components. In some instances, communication units 303 can include or have access to various components, such as serializer-deserializer (SerDes) units configured to serialize data to be output or deserialize data received as input; communication ports, connections, interface units, or the like; communication lines (e.g., electrically conductive signal traces, electrically conductive wires, optical fibers, cables, etc.); routing or data permutation components (e.g., internal routing or permutation components such as switching components; external components coupled to the processor device 301 such as routers, repeaters, switches, panels, or the like); or other components configured to facilitate one or more communication operations.

Chip-to-chip communication units 312 can include, for example, any device or component for communicating with another processor device (e.g., processor device 301, etc.), such as one or more serializer-deserializer units, one or more communication channels (e.g., signal lines, etc.), one or more connection components (e.g., ports, pins, connection pads, etc.), or the like. In some instances, a processor 301 can include a plurality of chip-to-chip communication ports to facilitate direct communication with a plurality (e.g., four, eight, sixteen, etc.) of other chips, such as according to a high-radix chip-to-chip communication topology (e.g., dragonfly topology, hyperX topology, etc.), such as a topology having greater than or equal to eight chip-to-chip communication links per processor device 301. In some instances, chip-to-chip communication units 312 can include units configured to communicate with processor devices that are geographically close to or far away from the processor device 301 (e.g., in a same or different compute node as the processor device 301; in a same or different rack; etc.). In some instances, chip-to-chip communication units 312 can include connections to a plurality of distinct chips, a plurality of connections to a single chip, or both. In some instances, chip-to-chip communication units 312 can include chip-to-chip communication units 312 associated with one or more bidirectional communication channels, one or more unidirectional communication channels, or both. In some instances, chip-to-chip communication units 312 can include deterministic communication units configured to perform chip-to-chip communication operations (e.g., send operation, receive operation, etc.) at one or more times predetermined by a compiler; deterministic communication units having a known or deterministic timing for one or more data transfer operations; or the like. In some instances, one or more timing units 305 can be used to provide synchronization for one or more processor devices 301 to facilitate deterministic-timing communication between chips.

A peripheral component interconnect express (PCIe) component 313 can include, for example, a communication device configured to facilitate communication between a processor device 301 and one or more other devices (e.g., computing devices; processor devices; data storage devices; auxiliary devices; etc.). In some instances, a PCIe unit 313 can include a communication system conforming to one or more PCIe communication standards (e.g., PCIe 6.0, PCIe 7.0, etc.). Although FIG. 3 depicts a PCIe unit 313, other communication units or communication standards can be used without deviating from the scope of the present disclosure. In some instances, a processor device 301 can include a deterministic processor device 301 configured to communicate non-deterministically via the PCIe unit 313 while maintaining determinism in the functional unit(s) 302 of the processor device 301 (e.g., according to methods described above).

In some instances, control unit(s) 304 can include one or more devices for controlling one or more operations of the functional unit(s) 302, such as device(s) configured to supply one or more control signals (e.g., assembly code or machine code instructions; switching signals, multiplexer selection signals, etc.) to one or more functional unit(s) 302.

In some instances, control unit(s) 304 can include one or more instruction control unit(s) 314 configured to supply computer-executable instruction(s) to one or more functional units. In some instances, an instruction control unit 314 can include a deterministic instruction control unit 314 configured to supply instruction(s) to the functional unit(s) 302 according to a predefined program order determined by the compiler; supply instruction(s) at one or more predefined times (e.g., clock cycles, etc.); or the like. In some instances, an instruction control unit 314 can include hardware configured to fetch (e.g., prefetch, etc.) instruction(s) from memory at a first time (e.g., before the instructions are needed; during a time of off-peak memory usage; at a time predetermined by a compiler; etc.) and provide corresponding instruction(s) to one or more functional unit(s) 302 at a second time (e.g., second time predetermined by the compiler, etc.)

In some instances, instruction(s) provided to a functional unit 302 by an instruction control unit 314 can be the same as or different from a corresponding instruction received by the instruction control unit 314. For example, in some instances, an instruction control unit 314 can include a unit configured to translate one or more compiled instructions (e.g., instructions in a first computing language or format output by a compiler, etc.) to one or more control signals (e.g., instructions in a second language or format; other control signals such as multiplexer selection signals or the like). In some instances, translating compiled instructions can include translating a memory-efficient stored instruction to a plurality of control signals that may include a greater data volume than the memory-efficient stored instruction. For example, in some instances, translating compiled instructions can include retrieving, from a memory functional unit 307, a compiled instruction; and providing, based on the compiled instruction, a plurality of control signals to one or more (e.g., a plurality of) functional units 302 over one or more (e.g., a plurality of) clock cycles. In some instances, a memory-efficient stored instruction can include a multi-operation instruction associated with a plurality of related operations (e.g., operations of a machine-learned model layer such as matrix multiplication, activation functions, convolution, attention, or the like), and the translated control signals can include a plurality of control signals (e.g., lower-level instructions, etc.) for executing the multi-operation instruction. In some instances, an instruction control unit 314 can include hardware configured to receive an instruction comprising one or more timing parameters (e.g., delay amounts, etc.) or repetition parameters, and output control signal(s) to the functional unit(s) 302 to cause the functional units to perform operations according to the timing or repetition parameters (e.g., at a predetermined clock cycle defined by a compiler, etc.). In some instances, the instruction control unit 314 can control a timing or a number of repetitions of the functional unit(s) 302 by sending control signals comprising timing or repetition data, or by sending raw control signals at a specific time or plurality of times configured to cause the functional unit(s) 302 to perform operations according to one or more timing or repetition parameters.

In some instances, timing and synchronization units 305 can include various components configured to perform synchronization operations, such as operations to track or communicate time data (e.g., current clock cycle data, etc.) to one or more functional units 302 or other components of a processor device 301. In some instances, timing and synchronization units 305 can include one or more of: one or more hardware-aligned counters 315, one or more software-aligned counters 316, or other timing or synchronization component.

Hardware aligned counters 315 may be used to establish a time base for electronic circuitry in each system, such as a clock, for example. Additionally, each system may include software aligned counters 316. Software aligned counters 316 may be synchronized, for example, based on one or more computer-executable instructions (e.g., compiled instructions determined by a compiler, etc.). Hardware aligned counters 315 and software aligned counters 316 may be implemented as digital counter circuits, for example, on each integrated circuit (e.g., each processor device 301 or each die thereof, etc.). For instance, hardware aligned counters 315 may be free-running digital counters (e.g., 8-bit counters) on a processor device 301 that are synchronized periodically. Similarly, software aligned counters 316 may be digital counters (e.g., 8-bit counters) that are synchronized based on timing markers triggered by one or more compiled programs.

In some instances, timing and synchronization units 305 can include one or more components 305 for internal synchronization of a plurality of components (e.g., functional units 302, etc.) of a processor device 301; one or more components 305 for external synchronization between a first processor device 301 and one or more other devices (e.g., a plurality of second processor devices 301, etc.); or both.

In some instances, synchronizing a first device (e.g., first processor device 301 or another device) with a second device (e.g., second processor device 301 or another device, etc.) can include, for example, synchronizing one or more hardware aligned counters 315 of the first processor device 301 with one or more hardware aligned counters of the second device. Synchronizing the hardware aligned counters 315 may occur periodically during the operation of each system and may occur at a higher frequency than synchronizing software counters 316, for example. Synchronizing hardware counters may include the first device sending a timing reference (e.g., timing bits representing a time stamp) to the second device over a communication channel (e.g., via chip-to-chip communication units 312, etc.). In some instances, a first system may send an 8-bit time stamp, for example. In such a scenario, a hardware counter 315 and software counter 316 of the first device may be maintained in sync locally. However, as the hardware counter 315 on a second device is synchronized to the hardware counter 315 on a second device, the software counter 316 on the second device may drift.

In some instances, software aligned counters 316 of a pair of devices can be synchronized by providing, in each of the devices (e.g., as part of a compiled program executed by the devices, etc.), one or more timing markers configured to be sequentially triggered (e.g., at predetermined positions in a compiled program corresponding to particular points of time or particular cycles). In some instances, timing markers in each device may be configured to trigger on the same cycle in each system. For example, a first program on a first device may trigger a timing marker on the same cycle as a second program on a second device when the devices' hardware aligned counters 315 are synchronized. In some instances, these timing markers may be used to synchronize software counters 316 of both devices. For example, in some instances, timing differences between the timing markers may correspond to a time difference indicative of a degree to which the two devices are out of synchronization, and synchronization can include adjusting a timing of one or more operations based on the time difference. For example, in some instances, a software aligned counter 316 can perform one or more delay operations at each of a plurality of timing markers, and a length of the delay can be adjusted based at least in part on a time difference between the first and second device at the timing marker. However, same-cycle timing is not required; for example, in some instances, a pair of timing markers may be offset by a known number of cycles, which may be compensated for during the synchronization process (e.g., by using different fixed delays, etc.).

In some instances, a timing difference (e.g., number of cycles, etc.) between timing markers may be constrained within a range. For example, a minimum time difference between timing markers in a first and second device may be based on a time to communicate information between the devices (e.g., a number of cycles greater than a message latency), and a maximum time difference between timing markers in the devices may be based on a tolerance of oscillators forming the time base on each system (e.g., if the time difference increases beyond a threshold for a given time base tolerance, it may become more difficult or impossible for the systems to synchronize for a given fixed delay). The minimum and maximum number of cycles may also be based on the size of a buffer (e.g., a first in first out (FIFO) memory) in each chip-to-chip communication circuit, for example.

In some instances, synchronizing hardware aligned counters 315 of a pair of devices can include sending, by a first device at a first time to, a timing reference; and receiving, at a second time t₁ by a second device, the timing reference. In some instances, the latency of such a transmission may be characterized and designed to be a known time delay Δt=t₁−t₀. In such instances, synchronizing the pair of devices can include setting, by the second device, a hardware aligned counter 315 to a value of (t₀+Δt) such that the hardware aligned counters 315 of both devices are synchronized.

In some instances, although the first and second devices can be architecturally similar (e.g., same) or different, synchronizing the devices can include, for example, assigning a first device as a designated sender device to send timing data, and designating a second device as a designated receiver device to receive timing data and adjust a timing of the receiver device's operations based on the timing data.

In some instances, software aligned counters 316 can be synchronized in a manner similar to synchronization of hardware aligned counters 315. For example, in some instances, a software aligned counter 315 can include or implement one or more timing triggers comprising one or more delays (e.g., no-operation (NOP) delays, etc.), wherein a plurality of devices are configured to perform a synchronized delay, such that one or more operations performed after the synchronized delay may be synchronized. For example, in some instances, a first device may send timing data to a second device at t0; and perform a predefined delay operation until t1. A second device may receive the timing data at (t0+Δt); and determine, based on the timing data, an amount of delay (e.g., number of clock cycles, etc.) to cause the second device to resume operations at t1.

In some instances, synchronization can include fine synchronization (e.g., as described above), coarse synchronization, or both. For example, during various points in operation, the first and second systems may be far out of sync. For example, during startup or after a restart (collectively, a “reset”), a set (e.g., pair, etc.) of devices may perform a coarse synchronization (e.g., using a 20-bit digital counter, etc.) to bring the time bases close enough so they can be maintained in alignment using the techniques described above (e.g., within a resolution of the hardware and software counters, such as 8 bits).

In some instances, synchronizing a number of devices greater than two can include performing similar operations with more than two devices, such as pairwise synchronizations at staggered times, such as pairwise synchronization of a processor device 301 with each of a plurality of neighbors in a chip-to-chip communication topology at a plurality of respective times; one-to-many (e.g., one-to-all, etc.) broadcasting of timing data; pairwise propagation of timing data between pairs of devices according to a propagation pattern or communication topology; or other mechanism for sending and receiving timing data and updating a timing of operations based on the timing data.

FIG. 4 is a block diagram of an example processor device 401 comprising a plurality of functional units 402 and a plurality of instruction control units 414. In some instances, processor device 401 can be configured to transmit (e.g., stream, propagate, etc.) operand data along a data flow axis 418 and transmit instruction data along an instruction flow axis 419. In some instances, the processor device 401 can be configured to perform one or more deterministic data flow operations, such as transmitting (e.g., streaming, etc.) operand data and instruction data at one or more predetermined times defined by a compiler, such that a compiler can control a timing of operand and instruction data flow to cause an instruction and corresponding operand(s) to intersect at a functional unit 402 for executing the instruction at a predetermined time (e.g., clock cycle) selected by the compiler. In some instances, a processor device 401 can be configured to access one or more external memory modules 420 (e.g., near-compute external memory modules 420, etc.), such as one or more external dynamic random access memory (DRAM) modules 421.

In some instances, a processor device 401 can be, comprise, be comprised by, or otherwise share one or more properties with a processor device 301. For example, in some instances, a processor device 401 can have any property described herein with respect to a processor device 301, and vice versa.

In some instances, a functional unit 402 can be, comprise, be comprised by, or otherwise share one or more properties with a functional unit 302. For example, in some instances, a functional unit 402 can have any property described herein with respect to a functional unit 302, and vice versa.

In some instances, a data flow axis 418 can include a direction, axis, or path along which operand data can flow. For example, in some instances, one or more functional units 402 can be configured to receive one or more input operands along the data flow axis; process the input operands to generate one or more output values; and transmit the output values along the data flow axis 418 to another functional unit 402, which can use the output values as input operands, and so on. In some instances, functional units 402 configured to perform related operations (e.g., pairs of operations associated with some machine-learned inference pipelines, etc.) can be located close together along the data flow axis 418; ordered along the data flow axis in an ordering corresponding to an ordering of one or more sets of related operations; or otherwise geographically arranged on a processor die to reduce a cost (e.g., latency, power cost, etc.) or increase a performance (e.g., throughput, etc.) of one or more operations (e.g., machine-learned inference operations, etc.). For example, in some instances, a series of related operations for machine-learned inference can include one or more of: matrix multiplication (e.g., multiplying machine-learned model parameters by input activations, etc.), activation function operations, mixing or combining operations (e.g., attention-based mixing, etc.), preprocessing or postprocessing operations, or other operations. In some instances, an ordering of such operations can include an ordering associated with one or more of: a transformer layer; a fully connected layer; an attention head; a convolutional layer; a pooling layer; a recurrent layer; a gating layer; or other machine learning architecture component. In some instances, a data flow axis 418 can include a physical axis or a logical axis, such as an operand flow path that may include or not include a straight-line operand flow path. In some instances, all or part of a data flow axis 418 can be orthogonal (e.g., logically orthogonal, physically orthogonal, etc.) to an instruction flow axis 419.

In some instances, an instruction flow axis 419 can include a direction, axis, or path along which instruction data can flow. For example, in some instances, an instruction control unit 414 can be configured to provide, to one or more first functional units 402, an instruction; and the first functional unit(s) 402 can be configured to execute the instruction and/or pass the instruction along to neighboring functional units 402 along the instruction flow axis 419. In some instances, a plurality of neighboring functional units along the instruction flow axis 419 can include a plurality of functional units 402 performing similar (e.g., same) functions, such as a plurality of memory functional units or the like. In some instances, a plurality of neighboring functional units along the instruction flow axis 419 can include a plurality of functional units 402 configured to execute the same instruction received from an instruction control unit 414 and propagated along the instruction flow axis. In some instances, an instruction flow axis 419 can include a physical axis or a logical axis, such as an operand flow path that may include or not include a straight-line operand flow path. In some instances, all or part of an instruction flow axis 419 can be orthogonal (e.g., logically orthogonal, physically orthogonal, etc.) to a data flow axis 418.

In some instances, a processor device 401 can include a deterministic processor device 401 comprising a plurality of deterministic functional units 402 configured to perform one or more operations at a predetermined time defined by a compiler at compile time. In some instances, a compiler can control a timing of one or more instruction and data flows to cause one or more instructions traversing the instruction flow axis 419 to intersect one or more operands traversing the data flow axis 418 at a functional unit 402 scheduled to execute the instruction(s) on the operand(s) at a predefined time instant selected by the compiler.

In some instances, a processor device 401 can include a plurality of functional tiles 402, which can include functional units 402 arranged in a tiled arrangement on a processor die. The functional tiles 402 can perform various functions such as vector-matrix multiplication, switching of data along different circuit pathways, and local data storage and retrieval. In some instances, functional tiles 402 can share a common system clock. In some instances, functional tiles 402 can include one or more sets of interconnected functional tiles 402 processing the same data, such as interconnected functional tiles 402 that are adjacent along a data flow axis 418; at a same location along an instruction flow axis 419; or the like. In some instances, a plurality of interconnected functional tiles 402 processing the same data can be referred to herein as a “lane” or “Superlane.” For example, in some instances, each functional tile 402 in a Superlane can be subdivided into 16 sub-tiles, and a set of subtiles processing the same data can be referred to herein as lanes. A set of data that is processed by one Superlane is referred to herein as a stream. In some instances, each lane in a tile of a Superlane can be configured to process one byte (e.g., one byte per clock cycle, one byte at a time, etc.).

In some instances, an instruction control unit 414 can be, comprise, be comprised by, or otherwise share one or more properties with an instruction control unit 314. For example, in some instances, an instruction control unit 414 can have any property described herein with respect to an instruction control unit 314, and vice versa.

In some instances, data between two adjacent functional tiles 402 can flow bidirectionally, or can primarily (e.g., most or all of the time) move in one direction along a lane or Superlane. In some instances, a first Superlane can have a direction of flow along the data flow axis 418 that is the same as or different from a direction of flow of a second Superlane. In some instances, operand data can be transferred along the data flow axis 418 at every clock cycle of a processor device 401. In some instances, when processing of operand data is complete in one Superlane, the data can be either returned to a host computer comprising the processor device 401 or transferred (e.g., by permute/routing functional units 311, etc.) to another Superlane for additional processing.

In some instances, a Superlane can process streams of data in 16 lanes. In some instances, each instruction can be performed on all 16 lanes at once, and then, if required by the instructions being executed, in the next Superlane in a subsequent cycle, and so forth. For example, in some instances, if a processor device 401 contains N (e.g., 20, etc.) adjacent Superlanes, then an instruction can be passed to N adjacent functional tiles 401 (e.g., over the course of N clock cycles, etc.), and each instruction can execute on all 16*N (e.g., 320) lanes across the N Superlanes. In some instances, a processor device 401 architecture can include an architecture that lacks register files, and a compiler can schedule the streaming data to be available to the functional tile 402 at a predetermined designated time to execute a designated instruction.

An external memory module 420 can include, for example, a memory device that is external to the processor device 401, such as a memory device on a separate die from the processor device 401 or the like. In some instances, an external memory module 420 can have one or more properties that are the same as or different from one or more properties of a memory functional unit 307. For example, in some instances, an external memory module 420 can include any memory type or device type described herein with respect to a memory functional unit 307. As another example, in some instances, an external memory module 420 can use a first type of memory that is different from a second type of memory used in an on-chip memory functional unit 307. For example, in some instances, a memory functional unit 307 can include a low-latency memory type such as SRAM, and an external memory module 420 can use one or more lower-cost or higher-storage-capacity memory types, such as dynamic random access memory (DRAM). Other memory types are possible without deviating from the scope of the present disclosure (e.g., SRAM or other non-volatile memory (NVM) such as 3D NOR memory, NAND memory, FLASH memory, phase change memory such as 3D Crosspoint memory, a next-generation ferroelectric memory, or a Nanotube RAM, etc.). For example, in some instances, an external memory module can have any property described herein with respect to an external dynamic random access memory (DRAM) module 421, and vice versa.

In some instances, an external dynamic random access memory (DRAM) module 421 can include one or more dynamic random access memory (DRAM) components, such as double data rate synchronous DRAM (DDR) such as DDR5, low-power double data rate synchronous DRAM (LPDDR), synchronous DRAM (SDRAM), low-random-transaction-rate DRAM having a low random transaction rate relative to one or more other memory device types (e.g., SRAM, etc.), or other DRAM component(s).

In some instances, an external memory module 420, 421 can include a deterministic memory device configured to perform one or more operations at a predetermined time defined by a compiler at compile time; a deterministic memory device having a known or constant latency for one or more operation types (e.g., read latency, write latency, etc.); or the like.

In some instances, an external memory module 420, 421 can include a plurality of memory banks, wherein each bank has a plurality of rows for storing data. Each memory bank can be addressable by a processor device 401 for writing data to selected rows in selected banks and for reading data from selected rows in selected banks, wherein data can be read a predetermined time-period before the data is required to arrive at one or more compute element(s) of the processor 401 and data can be written to a memory at a first pre-determined time-period that does not coincide with a memory refresh scheduled to occur at a second predetermined time.

In some instances, an external memory module 420, 421 can include various features to enable high-bandwidth memory access, high levels of memory concurrency, or the like. For example, in some instances, an external memory module 420, 421 can provide deterministic memory access functions (e.g., deterministic-latency operations, etc.) to enable a compiler to control a timing of a plurality of data read, write, or refresh operations; control a level of memory concurrency for accessing a plurality of operands or other data from an external memory module 420, 421; or other memory control functions. As another example, in some instances, an external memory module 420, 421 can include a plurality of concurrently accessible memory banks (e.g., memory banks configured to be active simultaneously, etc.), thereby increasing a memory bandwidth of the external memory module 420, 421. In some instances, an external memory module 420, 421 can be configured to access a full row of memory (e.g., without reference to a column decoder, etc.) at each read or write operation. In some instances, a compiler can provide explicit control of memory location allocations, data path routing, and the like to increase (e.g., maximize or nearly maximize, increase relative to partial-row memory access, etc.) a level of memory concurrency of external memory module 420, 421 operations.

In some instances, an external memory module 420, 421 can include a deterministic memory module having low-random-transaction-rate (low-RTR) memory (e.g., DRAM banks, etc.), and a processor device 401 can provide one or more deterministic operations to reduce (e.g., eliminate, etc.) a need for or usefulness of high-RTR memory. For example, in some instances, a plurality of simultaneously active low-RTR memory banks can be used to provide memory access having one or more performance properties (e.g., bandwidth, latency, etc.) equivalent to high-RTR memory.

In some instances, an external memory module 420, 421 can have one or more features to reduce a power consumption of the external memory module 420, 421 compared to some alternative implementations. For example, in some instances, an external memory module 420, 421 can be placed in close proximity to a processor device 401 to reduce (e.g., minimize or nearly minimize) an amount of power consumed in reading or writing data to the memory module 420, 421 (e.g., due to lower capacitive loading of short signal traces, etc.). In some instances, placing an external memory module 420, 421 in close proximity to a processor device 401 can include connecting the module 420, 421 to the processor device 401 in various manners, such as by face-to-face coupling (e.g., using wafer stacking technology, etc.) or another connection technique (e.g., passive interposer, active interposer, etc.). In some instances, a low-power external memory module 420, 421 can include a memory component (e.g., DRAM component) having sense amps attached directly to row input/output (e.g., without a logic layer or without data buffer(s), etc.).

In some instances, an external memory module 420, 421 can include one or more logic dies and a plurality of memory banks, such as a logic die coupled to a plurality of DRAM banks by through-silicon via and to a processor device 401 in a face to face configuration, etc. In some instances, a logic die can include row buffers for interfacing the processor device 401 to one or more memory components. The memory component(s) can also have an array core and a row decoder. During a read operation, the row decoder can select a row of array core and the entire row from the selected row can be transferred from the memory component to row buffers on the logic die. In some instances, a memory component or an external memory module 420, 421 can lack column decoders and can read or write an entire row during each R/W cycle. In some instances, a memory plane can include 3D NOR memory.

In some instances, an external memory module 420, 421 can provide a global address space available to a plurality of functional units 402. For example, in some instances, global memory access can be facilitated by one or more permute/routing functional unit(s) 311 of a processor device 401 to allow any processor 401 component at any location on a die to access data residing in any memory bank element of an external memory module 420, 421 or memory functional unit 307.

For example, in some instances, a streaming processor device 401 can provide operand data movement along a data flow axis 418 automatically (e.g., at every clock cycle, etc.), while one or more permute/routing functional unit(s) 311 can provide (e.g., responsive to one or more compiled instructions, etc.) operand data movement along an instruction flow axis 419. Further details of an example permute/routing functional unit 311 providing operand data movement along an instruction flow axis 419 are provided below with respect to FIG. 5.

In some instances, a processor device 401 can have sufficient permute/routing functional unit(s) 311 or data flow operations (e.g., routed data flow, automatic or unrouted data flow, etc.) to enable any retrieved data to be mapped to any functional unit 302 or port thereof. In some instances, permute/routing functional unit(s) 311 can provide additional operations in association with memory retrieval, such as data reshaping, padding (e.g., padding a size of a tensor by adding a plurality of zeros, etc.), duplication, or other data routing operations.

In some instances, a processor device 401 and external memory module 420, 421 can operate deterministically (e.g., with deterministic timing, order of operations, etc.), and can have various features to take advantage of such determinism. For example, in some instances, a deterministic processor device 401 can initiate one or more data retrieval operations a predetermined time period before the retrieved data is required to arrive at one or more corresponding compute elements. This can be used, for example, in combination with slow dense memory that may not necessarily provide low-latency or high-RTR performance of individual read operations, as read operations can be scheduled sufficiently far in advance to enable lower-RTR memory device(s) to perform similarly to a high-RTR memory of some alternative implementations. As another example, in some instances, given a processor device 401 that is deterministic, an external memory module 420 can perform non-destructive row reads, as each row can write new data if aligned with a closing row. This can provide for, for example, improved performance, reduced power usage, or both. In some instances, a deterministic processor device 401 can deterministically write new data or deterministically refresh existing data to the row of the DRAM, thereby enabling higher write bandwidth and better management of a refresh function. In some instances, a refresh function can be performed with new data by accessing a DRAM write register loaded with new data. In some instances, the processor device 401 can also treat the external memory module(s) 420, 421 as a circular read/write access medium having an opportunity to read and write every row location. For example, a row address line of an off-chip deterministic near-compute memory unit 420, 421 can be coupled to a clock. The row address line can be configured to receive a row address from the processor device 401 and increment every clock cycle in accordance with the circular medium access until the row address loops back without explicit addressing. This pattern can provide for even further power reduction and performance improvement while implicitly incorporating refresh support.

In some instances, a processor device 401 can use one or more memory functional unit(s) 307 (e.g., SRAM units, etc.) or another buffer device (e.g., external SRAM units interposed between a processor device 401 and external DRAM module 421, etc.) as a buffer to temporarily store data retrieved from the external memory module(s) 420, 421, or the processor device 401 can be configured to provide retrieved data directly to one or more functional unit(s) 402 for processing or routing (e.g., traversal of a data flow axis 418, etc.).

FIG. 5 is a block diagram of an example tensor streaming processor device 501 according to example implementations of aspects of the present disclosure. The tensor streaming processor (TSP) device 501 can include a plurality of functional slices 502, along with a plurality of data paths 518a, b, c, d, e between the functional slices 502. In some instances, the functional slices 502 can include one or more vector functional slices 510, one or more memory functional slices 507, one or more permute/routing functional slices 511, and one or more matrix functional slices 509. In some instances, a tensor streaming processor 501 can further include a plurality of communication units 303 (e.g., PCIe unit(s) 513, chip-to-chip communication unit(s) 512, etc.); a plurality of instruction control unit(s) 514; or other component(s).

In some instances, one or more of a processing device 501, functional unit 502, communication unit, memory functional unit 507, matrix functional unit 509, vector functional unit 510, permute/routing functional unit 511, chip-to-chip link 512, PCIe 513, or instruction control unit 514 can be, comprise, be comprised by, or otherwise share one or more properties with a component having a similar (e.g., same, etc.) name or part number described herein with respect to another Figure, such as FIG. 3 or 4. For example, in some instances, a processing device 501 can have any property described herein with respect to a processing device 301 or processing device 401, and vice versa; a functional slice 502 can have any property described herein with respect to a functional unit 302 or functional unit 402, and vice versa; and so on.

In some instances, a processor device 501 can include one or more functional regions or sets of functional units 502 with the same functionality executing the same instructions, such as functional tiles 502 located in similar positions in different Superlanes (e.g., at a same point along a data flow axis 418, etc.). In some instances, such a functional region or set of functional units 502 with the same functionality executing the same instructions can be referred to herein as a functional ‘slice.’ In some instances, a processor device 501 can include one or more sets of directly connected slices of the same functional modules, encompassing all the Superlanes, is referred to herein as a ‘partition’.

In some instances, a TSP 501 can include a plurality of slices, wherein each slice in a TSP can perform any of a variety of functions under the control of instructions transferred from buffers in the Instruction Control Unit 514. For example, in some instances, functional slices 502 can include memory functional slices 507 for memory storage and retrieval for data in a Superlane (MEM); functional slices 502 (e.g., matrix or vector functional slices 509, 510, etc.) for integer (INT) arithmetic or floating point (FPU) arithmetic; or permute/routing functional slices 511 for transferring data between Superlanes (NET or SXM). In some embodiments, each of the functional slices 502 can operate independently, and operations of different functional slices 502 can be coordinated using barrier-like synchronization instructions.

For example, the memory functional slices 507 can perform Read and Write operations but not Add or Mul, which can in some instances be performed only in matrix functional slices 509 and vector functional slices 510. In some instances, all of a plurality of tiles in a functional slice 502 can execute the same set of instructions, so it is possible to locate all of the common instruction decode and dispatch logic into the ICU 514, and partition the normal instruction execution pipeline into two sets of instructions: (i) instruction fetch, decode, and parceling and (ii) operand read, execute, and writeback. Functional slices 502 or components thereof can operate without having to receive explicit instructions, or only receiving intermittent or limited instructions, from the ICU when the tiles are dedicated to a specific function, potentially simplifying operation of the processor.

In some instances, a functional slice 502 can include a plurality of functional tiles 402 (e.g., tiles organized along an instruction flow axis 419, etc.). In some instances, functional tiles in the same functional slice 502 (but not necessarily the same Superlane) can execute instructions in a “staggered” fashion where instructions are issued tile-by-tile within the slice over a period of N cycles. For example, the ICU 514 for a given slice may, during a first clock cycle, issue an instruction to a first tile of the slice (e.g., the tile directly connected to the ICU of the slice), which is passed to subsequent tiles of the slice along an instruction flow axis 419 over subsequent cycles.

In some instances, a processor device 501 can include a first and second matrix functional slice 509 or first and second set of matrix functional slices 509; a first and second permute/routing slice 511 or first and second set of permute/routing slices 511; a first and second memory slice or first and second set of memory slices 507; and a first vector functional slice 510. For example, in some instances, each Superlane can include a first set and second set of matrix multiplication tiles (MXM1 and MXM2), a first and second set of data path switching tiles (SXM1 and SXM2), a first and second set of memory tiles (MEM1 and MEM2), and a first set of vector calculation tiles (VXM1), wherein just one tile in MXM1 transfers data with one tile in SXM1, wherein just one tile in SXM1 transfers said data with just one tile in MEM1, wherein just one tile in MEM1 transfers said data with just one tile in VXM1, wherein just one tile in VXM1 transfers said data with just one tile in MEM2, wherein just one tile in MEM2 transfers said data with just one tile in SXM2, and wherein just one tile in SXM2 transfers said data with just one tile in MXM2.

In the above example, data transfers are entirely in one direction, for example MXM1 to SXM1 to MEM1 to VXM1 to MEM2 to SXM2 to MXM2. However, in other examples, data transfers can occur in multiple (e.g., two, etc.) directions, for example, one set of data transfers from VXM1 to MEM1 to SXM1 to MXM1, and another set of data transfers from VXM1 to MEM2 to SXM2 to MXM2.

In some instances, each Superlane, and in some instances the entire TSP 501, can execute a single set of instructions, such that the TSP 501 may be considered as a single processor core. However, in some instances, the TSP 501 Superlanes can be partitioned into two sets of functional modules. For example, in a split architecture with only one central vector functional slice 510, a central vector multiplication tile that contains 16 ALUs can allocate the ALUs to either set. In other instances, additional vector functional slices 510 may be allocated to a set. The additional vector functional slices 510 may be physically or logically located, for example, next to one of the matrix functional slices 509.

For at least one embodiment, FIG. 5 can depict the silicon layout of a TSP 501 with multiple Superlanes, as well as processor chip to processor chip (C2C) interface modules 512 and the ICUs 514. In this example embodiment, there are 20 Superlanes forming the majority of the floorplan of the laid-out silicon circuitry. Surrounding the Superlane partitions is circuitry for the ICUs, modules for processor-to-processor communication, and modules for host-to-processor communication. In one embodiment, the host-to-processor modules comprise a PCIe (Peripheral Component Interconnect Express) circuit 513. In some instances, a host-to-processor communication module can bidirectionally transfer data from the host computer through a permute/routing functional slice 511 to and from a memory functional slice 507. In some embodiments, a processor-to-processor communication C2C module 512 directly transfers data to a permute/routing functional slice 511.

One example implementation of a TSP 501 chip contains 26.8 billion transistors on a 725 mm² die built in 14 nm ASIC technology, and is designed using standard EDA tools from circuit design through tape-out before fabrication. The die area splits about evenly between memory and compute units (not counting I/O). Instruction control requires only 3% of the die area. One Superlane in the example TSP 501 can be initially unused, so it can be connected to the rest of the architecture to replace any Superlane that is defective; this redundant feature adds only about 4% to the die area. In this embodiment, each memory partition can have 44 memory functional slices 507 each comprising 20 memory functional tiles 402.

In some instances, a TSP 501 can include a large on-chip Static Random Access Memory (SRAM), which can in some instances reduce or eliminate a need for external memory. For this reason, a TSP 501 may not need to include DRAM controllers and interfaces. However, a processor device 301, 401, 501 can include a processor device configured to interact with external memory (e.g., external DRAM, etc.) without deviating from the scope of the present disclosure. Some example TSP 501 chips can include an x16 PCI Express (PCIe) Gen4 interface to connect to a host processor (e.g., central processing unit of a host computing device, etc.). In some instances, compilers that execute on the host computer or another device can download the machine learning algorithm instructions and data to the TSP 501, typically from the host computer through the PCIe interface 513 through permute/routing functional units 311 (e.g., tiles, etc.) adjacent to the PCIe interface 513 into the memory functional slices 507 (e.g., MEM partitions comprising one or more memory functional slices 507, etc.). The TSP 501 can then autonomously execute the model by transferring the instructions and data in the MEM partitions into one or more functional slices 502. After processing, in some instances, results can be transferred from one or more functional slices 502 (e.g., vector functional slice(s) 510, etc.) back to the host computer (e.g., via one or more permute/routing slices 511 and via one or more PCIe devices 513.

### Streams

Machine learning algorithms can in some instances operate on vectors with scalar coefficients of a specified data type (e.g., INT8, FP16, etc.). In some instances, Superlanes of a TSP 501 can operate on data representing vectors, sometimes organized into rank-2 tensors. In some instances, a TSP 501 can operate on higher-rank tensors by using a compiler to transform higher rank tensors into rank-2 tensors. In some instances, a TSP 501 can implement a programming model that is a producer-consumer model where each slice in a partition acts as a consumer and a producer of one or more streams.

In some instances, a TSP 501 architecture can support a plurality of streams (e.g., 32 streams, etc.) in each set of tiles in two directions. In some instances, a number of streams can be dependent on the availability of wiring of the inputs and outputs for the stream registers. In some instances, each stream can automatically progress in a designated direction (e.g., designated direction along a data flow axis 418 or data path 518, etc.) on every cycle (e.g., moving 32 bytes each cycle via 32 streams, etc.). In some instances, inter-lane data movement (e.g., data operand movement in a direction other than the data flow axis 418, etc.) within a vector can be performed using a permute/routing functional slice 511.

When a set of data representing a vector is read from main memory, it can be given a stream identifier (0 . . . 31) and direction of flow in a Superlane. Once a vector is read into one or more stream registers in a lane, it can become a stream and flow towards a functional slice 502 that is scheduled to process the vector, and the functional slice 502 can process the vector to produce a result stream. As data in a stream flows through a slice, each functional module can intercept the data and perform a calculation (if the module is calculational), or move data between lanes (e.g., in permute/routing functional slice(s) 511).

The stream registers can be used to transfer operands and results between slices. An example software pattern can include reading operand data from one or more memory functional slices 507 that is then subsequently consumed and operated on by a downstream arithmetic slice (e.g., matrix functional slice 509, vector functional slice 510, etc.). The results of the operation can then be transferred to another stream such that they can be written back to memory. For example, a Z=X+Y operation might be performed by executing four instructions: Read S1, X and Read S2, Y are executed on two memory functional slices 507 and directed toward a vector functional slice 510 to perform the Add S1, S2, S3. Then the result can be stored back to a memory functional slice 507 via a Write S3,Z.

An instruction can operate on data from different streams. For example, ADD S1, S2, S3 adds each value in stream 1 to the corresponding value in stream 2 and stores the results in stream 3.

In some instances, a functional slice 502 can include a functional unit 302 configured to perform a given operation (e.g., operation associated with a single instruction received from an instruction control unit 514, etc.) for a plurality of repetitions on operands streamed over a plurality of clock cycles. For example, in some instances, a functional slice 502 or component thereof (e.g., functional tile, etc.) can be configured to receive an instruction comprising repetition data indicative of a number of times to repeat a given operation; a number of clock cycles to delay between repetitions of the given operation; or other repetition data. Based on the instruction, the functional slice 502 can perform, at each of a plurality of clock cycles, the given operation on one or more operands arriving in one or more streams (e.g., Superlanes, etc.) at each of the plurality of clock cycles.

A lane structure configured to hold one byte per lane can be well suited for INT8 data, but larger operands (INT16, INT32, FP16, or FP32) can also be formed by combining streams. This approach can provide for a compiler to operate, for example, on 320-element vectors for all data types. Wider data types can be assigned to adjacent streams along aligned boundaries. For increased reliability, a Superlane can apply a 9-bit error-correction code (ECC) across all 16 lanes, correcting nearly all errors. A TSP 501 can log these errors and report them to a host computer. In one embodiment, the ECC protocol is SECDED (single-error correction with double error detection). Before a functional slice operates on a stream of data, it can check the ECC bits to ensure data integrity before operating on the data.

In some instances, each element of a stream can be 1-byte, with larger data types (e.g., INT16, INT32, and FP32) constructed from several streams (2, 4, and 4 respectively). Multi-byte data types can be handled such that they are always stream-aligned based on the size of the data type. For instance, INT16 can be aligned on a stream pair, bi-stream, and INT32 can be aligned on a quad-stream (e.g., one set of four adjacent data paths 318 per INT32 value, etc.). Data alignment can be accomplished by the compiler or through an application programming interface (API).

In some instances, each stream can have one or more “valid/empty” bits precisely tracking the stream's load-to-use time beyond which the stream is considered logically dead and no longer propagated, which can achieve a reduction in power consumption of the TSP 501.

### The Instruction Control Unit

Some instructions in the ICUs 514 can be common to all functional slices 502. As such, the instructions can contain common instructions like NOP and Repeat, and synchronization instructions Sync and Notify to allow the functional slices 502 to be initially synchronized, so a compiler can accurately determine instruction execution times and allow cooperative parallelism among the functional slices. ICUs 514 can retrieve pages of instructions in the MEM partitions, sending Ifetch instructions across side channels in the memory slices, and receiving the instructions from memory back along the same side channel.

The ICUs 514 can provide explicit instruction fetching for the slices with the Ifetch instruction, and inter-slice synchronization using the Sync and Notify instructions to perform a chip-wide barrier synchronization among participating functional slices. A repeated-NOP (no-op) instruction can allow for precise cycle-by-cycle control of inter-instruction delay. For example, a compiler can have cycle-accurate control when scheduling two operations A and B using an intervening NOP so that N clock cycles separate the operations A and B, i.e., Operation A then NOP (N) then Operation B.

A compiler can use explicit NOPs to provide temporal separation between two instructions in the program order. A NOP can have a repeat count 16-bit field which allows one NOP to wait between 1 ns and 65 μs for a 1 GHz clock frequency. A compiler can use NOP instructions to control relative timing of the functional slices 502 and data on which the functional slices operate. A repeated NOP can be implemented in the ICU 514 and can be common to all functional slices 502. While a NOP instruction can be the most common instruction, the NOP instruction may not be included in the specification for a machine learning model, but rather may be inserted into the instructions generated from the model by a compiler.

In some instances, a vector functional slice 510 can include a central vector functional slice 510 containing 16 Arithmetic Logic Units (ALU) per lane. Each ALU can perform, for example, a 32-bit calculation using aligned groups of four stream bytes as operands. In addition to the usual arithmetic and logical operations of some conventional ALUs, ALUs of a vector functional slice 510 can be configured to convert between integer and floating-point formats. In some instances, a vector functional slice 510 can be configured to perform some predefined normalization functions such as ReLU and the hyperbolic tangent (tanh) as well as exponentiation and reciprocal square roots, allowing programmers to build their own normalization functions.

In some instances, a tensor streaming processor device 501 can be organized into a plurality of Superlanes, and a vector functional slice 510 can implement, for each Superlane, a 4×4 mesh of vector ALUs using the 16 vector ALUs per lane. In some instances, an ALU can be configured to receive 32-bit input operands, wherein each of an ALU's 32-bit input operands are organized along an aligned quad-stream group.

In some instances, a vector functional slice 510 ALUs can include stateless ALUs, such as ALUs that do not produce condition codes or status flags from the last instruction. For example, in some instances, instead of condition codes or status flags, a vector functional slice 510 can provide both saturating and modulo variants (add_sat, add_mod and mul_sat, mul_mod) for addition and multiplication, which can allow differing semantics for handling arithmetic exceptions. In some instances, a tensor streaming processor 501 can support chaining together two or more vector ALUs within each lane, allowing multiple ALU operations to be performed without transferring the intermediate results to main memory, saving a write and subsequent read of each intermediate result. This can in some instances allow for efficient parallel implementations of algorithms for batch normalization, quantization, or more complex activation functions like the leaky ReLU activation function, for example.

In some instances, a matrix functional slice 509 partition can include a plurality of independent regions (e.g., grids, etc.) of multiply-accumulate modules, such as four independent 320-by-320 grids of multiply-accumulate (MACC) modules. In some instances, each 320 by 320 grid can include 20 16 by 16 sub-grids that each produce a partial-sum/dot product result each cycle and pass the result to an adjacent functional tile 402 for use in its computations. In some instances, an N by N grid can use N streams each with N bytes to install N² parameters (e.g., 8-bit weights (IW), etc.) in each grid on every cycle. Using all 32 streams in each direction can allow weights to be placed simultaneously in multiple matrix functional slice 509 partitions, loading 409,600 weights (e.g., all weights of some example machine-learned models or model partitions, etc.) on-chip in less than 40 cycles. With weights installed, every cycle the matrix functional slice(s) 509 can generate a new dot-product (e.g., INT32 dot product, etc.) of input activations with installed weights. The features output from the matrix functional slice(s) 509 can be accumulated using accumulators on each INT32 or FP32 output stream.

In some instances, a matrix functional slice 509 can support calculations for multiple numerical formats by combining results from multiple lanes. For example, in some instances, a matrix functional slice 509 can support both 8-bit integer (INT8), and 16-bit floating point (FP16), by using two 320×320 byte-planes in tandem for the 16-bit floating point results. In some instances, a 320-element sum can be produced for each output with only a single rounding step at the end to convert to INT32 or FP32 results. Matrix functional slice 509 processing can include, for example, one or more of the following operations (instructions): LW—load weights from data flows (streams) to weight buffer; IW—install weights from data flows (streams) or LW buffer into the 320×320 array; ABC—activation buffer control to initiate and coordinate arriving activations; ACC—accumulate either INT32 or FP32 result from M×M.

In some instances, each MACC unit can have two 8-bit weight registers and two 32-bit accumulators. On each cycle, each MACC unit can multiply the stored weight values by a pair of activation values from the streaming data. In some instances, each 16×16 sub-grid can compute an integer partial sum in one cycle and a complete 320-element fused dot-product in 20 cycles. In some instances, a MACC unit can instead operate as a single FP16 MACC, but these operations can require two cycles, reducing throughput by 75% relative to INT8 operations. In some instances, each matrix functional slice 509 partition can have 320×320 MACC units producing 409,600 INT8 operations or 102,400 FP16 operations per cycle. Using all 32 streams in each direction, the TSP can load all 409,600 weight registers in less than 40 cycles.

The permute/routing functional slice(s) 511 (sometimes referred to herein as switch units, ‘SXM’ or ‘NET’) can execute functions for the transposition, permutation, shifting and rotation of data elements. Collectively, these operations can be used for performing tensor reshape operations, such as tensor reshape operations associated with one or more machine learning operations. For example, in some instances, a permute/routing functional slice 511 can rotate or transpose a stream of data across the lanes. In some instances, a permute/routing functional slice 511 can duplicate bytes to fill a vector or zero any of the vector elements to pad values. In some instances, permute/routing functional slice 511 can be the only tiles of a processor device 511 that communicate between Superlanes. Further details of some example permute/routing functional slices 511 are disclosed in U.S. Pat. No. 10,754,621, incorporated herein by reference.

Data movement on-chip can be carried out by routing data along one or more pathways, such as pathway(s) where data is transferred between SRAM and functional modules within each Superlane, and pathway(s) where the permute/routing functional slice 511 transfers data across lanes using two sets of lane shifters. The lane-shifters can in some instances be allocated in pairs to facilitate shifting a vector between a lane and its two adjacent lanes in a Superlane. Additionally, in some instances, the permute/routing functional slice 511 can provide a permute instruction that uses a programmed bijection to remap a plurality of lanes (e.g., 320 lanes, etc.) onto a set of similarly indexed streams, one per Superlane.

In some instances, permute/routing functional slice 511 can include one or more distributor slices. For example, a distributor slice within a permute/routing functional slice 511 can be used to arbitrarily remap a plurality of (e.g., 16) lanes within each Superlane. As streams pass through the SXM's distributor, they can be remapped at full bandwidth, or zero-fill any or all of the 16 elements. This can provide an efficient mechanism for common tensor operations like zero padding or rearranging elements of a convolutional neural network filter (e.g., 4×4 filter, etc.).

An example operation on tensor data types can include transposition. In some instances, a TSP 501 can support a two-dimensional transpose of 256 elements organized as 16 streams each with 16 elements. A transpose operation can take 16 incoming streams and produce 16 output streams with the rows and columns exchanged. This allows the efficient movement of data from the atomic 16-byte MEM word into 16 different MEM slices where they are now addressable. In some instances, a TSP 501 can include two instances of the SXM on-chip, one in each hemisphere. Each can issue, for example, two (2) transpose instructions, yielding a maximum of four (4) simultaneous transpose 16×16 operations.

In some instances, a tensor streaming processing device 501 can have a plurality of memory partitions (e.g., two partitions, etc.) each having 44 memory functional slices 507 comprising ECC-protected SRAM, with each slice comprising 20 tiles that provide a total capacity of 2.5 MiBytes (wherein a Mibyte is 1048576 bytes) per slice, giving the two MEM partitions a total capacity of 220 MiBytes. Each memory functional slice 507 can include, for example, at least two sets of memory cells referred to as ‘banks’. Each MEM slice can include pseudo-dual-port SRAMs that can service a pair of read and write requests simultaneously, assuming they are not targeting the same bank. In such instances, the 88 memory functional slices 507, each with 2 banks, can enable up to 176-way memory concurrency to read operands to or store results from streams. Banks of memory not being used can have their power reduced to reduce energy usage.

In some instances, the memory functional slices 507 can be configured to provide sufficient memory concurrency to supply a target number (e.g., 32, etc.) of operands per lane, every cycle. For example, in some instances 88 slices having 176-way memory concurrency can provide sufficient concurrency to supply 32 operands per lane each cycle. In some instances, memory functional slices 507 can be partitioned into 16-word bytes, each word distributed across a Superlane, and each byte of each word processed by one lane of the Superlane. In some instances, a memory functional slice 507 can perform two 16-byte reads and two 16-byte writes per cycle, as long as they access different banks, allowing it to both source and sink data in two directions across all lanes in a Superlane.

In some instances, on-chip memory can supply operands for each functional slice 502 by reading an address from a memory (MEM) functional slice 507, denoted MEMᵢ. In some embodiments, slices in each memory can be numbered 0 to 43, with MEM₀ closest to the vector functional slice 509 and MEM43 nearest to the permute/routing functional slice 511.

In some instances, memory partitions can enable the programming abstraction of a partitioned global shared address space with the address space laid out uniformly across the slices. In some instances, each memory functional slice 507 can support both direct and stream-indirect addressing modes. Read and Write operations can use direct addressing, since the address is fully specified in the instruction itself. Indirect addressing can use the contents of a stream, s, to specify an address map for a Gather or Scatter. With indirect addressing, the physical address can be transmitted within the stream value, providing a layer of indirection in the memory referencing.

In some instances, each memory functional slice 507 can have two dedicated dispatch paths, one for each port of the pseudo-dual-ported SRAM. Each memory instruction can undergo an additional address generation stage for strided references by computing the address aᵢ from the previous address aᵢ₋₁ and strides so that aᵢ=aᵢ₋₁+s between locations. Strided memory references can be accomplished using a sequence of countdown, step, and iters MEM instructions. For example, the following example assembly-language snippet, explicitly schedules read and write instructions at program time t=10 to iterate starting at address 0x1000, striding by 24 on each iteration, for 112 total vectors, as shown in the example below for MEM West slice 43.

```
.MEM West 43
.read
10: read 0x1000, s_0_e
  step 24
    iters 111
.write
10: write 0x00ff, s_16_w
  step 1
  iters 111
```

This iteration mechanism in the address generation circuitry can support for example, multiple levels (e.g., up to four-levels, etc.) of nested iteration allowing for multi-dimensional arrays to efficiently encode tensors as a short sequence of read or write, or gather or scatter, operations followed by countdown, step, and iter instructions to control the loop bounds. The countdown instruction can specify an inter-loop delay in cycles.

As a non-limiting illustrative example, consider a TSP 501 having a 1 GHz operating frequency of the TSP 501 clock. The stream register bandwidth, B, exported by each MEM interface on the East and West edge of each MEM partition can keep the functional modules adequately fed with data operands in order to saturate the peak arithmetic capacity of the functional modules. The stream registers can provide a combined capacity of 20 TiB/s of read (operand) and write (result) bandwidth (a Tib is a Mibyte of Mibytes).

To maximize stream concurrency, a compiler can allocate memory for concurrent stream operands associated with a single tensor into separate memory functional slices 507. For example, as the streams propagate through the MEM system they can “pick up” the arguments from a plurality of separate memory functional slices 507 enroute to one or more other functional slices 502 (e.g., matrix functional slices 509, etc.). In some instances, a compiler can explicitly schedule individual banks of each MEM slice to achieve fine-grain memory management. This can enable design patterns and use-cases where simultaneous reading of operands from one bank and writing of results to the other bank in the same memory functional slice 507. As an example, a transpose instruction can take 16 input streams and produce 16 output streams with the rows and columns transposed. By using the bank concurrency available within each memory functional slice 507, it is possible to use the pseudodual-ported SRAM for dual read/write accesses per memory functional slice 507.

In some instances, a TSP 501 can include a memory system that is unlike a memory system of a conventional central processing unit (CPU). For example, some conventional CPUs may rely on a memory hierarchy to implicitly move data between caches to service load/store operations. Cache hierarchies can introduce a reactive agent in the data path and can introduce undesired unpredictability, or non-determinism, in the data path to provide the illusion of sequentially consistent memory transactions within the memory hierarchy.

In some instances, a TSP 501 can differ from a conventional CPU memory by providing a memory management layer that identifies the memory concurrency on an operation by operation basis. As an example, the Python code below shows memory management for an example transpose operation; an instruction that takes 16 streams as input and creates 16 streams of output. The g.malloc function returns a tensor of addresses allocated across 16 memory slices, one for each concurrent stream:

```
# Read from 16 slices onto 16 slices
# Transpose data
# Write from 16 slices into 16 slices
import groq as g
tensor = g.random_tensor(shape=[1024, 320],
    dtype=g.Int8, layout=[64, 16])
streams_16 = tensor.read(streams=range(16))
streams_16_t = g.transpose16(streams_16)
out_addrs = g.malloc(shape=[1024, 320],
      layout=[64, 16])
streams_16_t.write(out_addrs)
```

In some instances, the memory functional slices 507 can store very long instruction word (VLIW)-like instructions, such as instructions that are 2,304 (144×16) bytes wide. In some instances, a program can fetch instructions when the memory functional slices 507 are otherwise idle. For example, in some implementations, instruction fetches can require less than 10% of the total memory bandwidth of the memory functional slices 507. Instructions can be decoded and loaded into queues, allowing the program to prefetch. To reduce code size, a REPEAT N instruction can repeat a previous instruction N times. In some instances, a program can specify a NOP instruction to last for N cycles.

Each functional slice 502 can have a predefined set of instructions (e.g., Read, Write, Add, Mul, etc.) that define its supported operations. Furthermore, functional slices 502 can consume operands from, and produce results to, streams. A more complex sequence of operations, a microprogram, can be composed of one or more slices 502 coordinating in a producer-consumer manner to create one or more output streams. This can be accomplished by logically chaining multiple slices 502 together to consume input data from up-stream slices 502, operate on that data to produce a new result stream, where it later can be consumed by a down-stream slice 502 in a similar manner. In some instances, each functional slice 502 can choose a direction of its result stream. With this cooperative producer-consumer model operating on data streams, more elaborate operations can chain together different functional slices 502, for example, where a composite function, F (x, y, z)=MEM(x)→SXM(y)→M×M(z), is an amalgam of several functional slices 502 chained together.

This dataflow composition exploits ‘data flow locality’ by passing the same data across multiple functional slices 502 which can operate on the data to produce some output stream. The output from one functional slice 502 can be transferred to the input of another slice 502 allowing for chaining of operations through a common stream register.

In some instances, the underlying data type supported by a TSP 501 can be a vector. For example, in some instances, number of elements in each vector can vary from 16 elements, one Superlane, all the way to 320 elements using all 20 Superlanes on-chip. That is, the minimum vector length, or minVL, can be 16 bytes and the maximum vector length, or maxVL, can be a 320 byte-sized element array. Because the vector length can vary from 16 to 320 elements, instructions can configure each tile for a low-power mode to effectively power down any unused Superlane (row of the mesh) and reduce the power consumed. This scalable vector approach allows the vector length to grow from 16 to 320 bytes in 16-lane steps, powering-down the unused tiles, yielding a more energy-proportional system.

In some instances, an instruction set architecture of a TSP 501 can provide temporal information about each instruction to allow a compiler precise control of each instruction's dispatch time. For example, in some instances, each instruction can be augmented with one or more of the following temporal parameters:

dfunc functional delay—each instruction requires 1 or more cycles to produce its stream output. A functional delay timing parameter can allow the compiler to reason about when the output of an instruction will be available on the architecturally-visible stream registers.

dskew instruction-operand skew—the timing relationship between the instruction dispatch time relative to when its stream operands are required. An instruction-operand skew parameter on each instruction can inform a compiler how to schedule the operand arrival times with the instruction dispatch time in order to get them to properly intersect in time and space.

Such parameters can be useful to track the exact spatial relationship between instructions and operands.

In some instances, a programming model for a TSP 501 can include, for example, the following two elements: (1) scheduling specific data paths in hardware, and (2) exposing temporal information about an instruction's execution latency through the Instruction Set Architecture (ISA), so that the compiler's back-end can precisely track the position and time-of-use of any stream on-chip.

A compiler can use NOP instructions to control the relative timing of the functional slices 502 and the data on which they operate. A NOP can have, for example, a repeat count 16-bit field which allows one NOP to wait from Ins up to 65 us for a 1 GHz clock. The NOP instruction can be implemented in the ICU's tile and can be common to all functional slices. The NOP can allow the slice to turn off the clock when performing no operations for anything longer than a few cycles (i.e., n>4 cycles).

Each functional slice 502 can be independent; however, the compiler can keep track of a logical program time. Conceptually this can be similar to a program counter in a conventional CPU, except the compiler can track the state of a plurality of (e.g., 144, etc.) independent program queues on a cycle-by-cycle basis. So, at logical time t the compiler can know the state of each Instruction Queue (IQ) inside each Instruction Control Unit. NOP instructions coordinate the temporal relationship between instructions in the same IQ, or between instructions in different IQs. In addition to repeated-NOPs, a higher-level synchronization across all functional slices 502 on a chip can be enabled in order to reason about program correctness. For example, in some instances, Sync and Notify instructions can provide a barrier synchronization mechanism across all independent queues on the TSP 501. One IQ can be designated as a notifier configured to issue a Notify instruction while all other IQs can be parked on a Sync instruction. The receipt of a Notify can be broadcast to all the IQs to satisfy the pending Sync and begin processing instructions again.

This barrier synchronization can be performed, for example, only once after the TSP 501 resets. However, in practice, some programs may start with a set of “preamble” instructions which configure each tile. After that a Sync instruction can be performed to ensure that all functional slices are aligned to the same logical time. In some example embodiments, a chip-wide barrier synchronization can be accomplished in 35 clock cycles, from the time a Notify is issued to the time a Sync is satisfied and retired to allow subsequent instructions to flow. After this barrier synchronization, the functional slices 502 can compute and communicate results in a synchronization-free manner through the stream registers.

Repeat (n, d) is an ICU instruction issued to repeat a previous instruction n times, with d cycles between each iteration. Allowing variable amounts of delay between iterations can allow a compiler to temporally align the repeated instruction with its operands in-flight. This simple but flexible iteration mechanism can allow vector functional slices 510 and matrix functional slices 509, which are often highly iterative, to encode their instructions more efficiently by making better use of main memory and reducing the number of Ifetch instructions compared to if the loop were unrolled.

An Ifetch instruction can have a single stream operand which carries the instructions in their program order, filling an instruction queue with, for example, 640-bytes (e.g., a pair of 320-byte vectors) of instructions. In some instances, all functional slices 502 can fetch instructions simultaneously with normal instruction execution. In some instances, a compiler can perform omniscient prefetching of the program's instructions to keep all 144 IQs busy on each cycle by inserting Ifetch instructions into every slice's instruction stream. In some instances, a TSP 501 or compiler can include a mechanism to ensure that IQs never are empty so that a precise notion of ‘logical time’ is maintained across the processor.

In some instances, a TSP 501 can be configured to transmit data along a stream without packet routing, arbitration, or the like. For example, on each tick of the core clock, the TSP 501 can propagate stream values by one stream register hop. The TSP 501 hardware can, for example, propagate stream values without tracking the origin or destination slice, such as by allowing streams to simply propagate until they fall off the edge of the chip or are overwritten by a functional slice 502. In some instances, a TSP 501 can use stream registers within each memory functional slice 507 to move data along a Superlane, and can use one or more permute/routing functional slices 511 to move data between Superlanes. An instruction can specify one or more source streams-direction pairs, and a target stream and output direction for the result, effectively providing direction routing of the stream data.

In some instances, a network of TSP 501 processors can be connected via Chip-to-Chip (C2C) modules 512. The processors 501 can logically behave as if all chips share a common clock and are connected via time multiplexed wires. TSP 501 chips connected via C2C 512 do not need to share a clock; reasonable alignment of the frequency of the clocks (measured in PPM) can suffice. In some instances, receive buffers in the communications modules can be large enough so that the expected PPMs of clocks don't require a realignment more than once per millisecond, or otherwise don't require realignment often enough to cause difficulty in scheduling between model executions.

In some instances, C2C modules 512 can either provide sufficient Forward Error Correction for data transfer between chips such that unrecoverable errors will occur <1 per week per chip when using all C2C links, or provide software with a mechanism to add additional redundancy so that errors will occur <1 per week per chip when using all C2C links 512. If error rates are lower at a lower transfer rate (e.g., 16 Gb/s), then SerDes can be configured to run at a lower rate for improved precision.

Transfers of data between TSP chips 501 during a compute phase of a program can be supported, e.g., while COMPUTE[i]. CHIP[A] is running on chip A, it may send data to COMPUTE [i].CHIP[B] on chip B, which may result in data being returned to COMPUTE[i].CHIP[B] and used before the computation completes. This can differ, for example, from some PCIe 513 implementations, which may only allow data to be transferred before and after a COMPUTE phase.

In some instances, each C2C 512 SerDes of a TSP 501 can be an independent link, e.g., each link may be the only connection to another device or may be one of multiple connections to another device. Multi-chip systems can be implemented in a variety of topologies for flexible packaging and deployment in rack-scale and cluster scale systems. Communication can occur in a pair-wise manner between a sender port and a receiver port. A sender can perform a MEM read to read an address a onto a stream heading toward a permute/routing functional slice 511. The permute/routing functional slice 511 can perform a Send on the C2C unit 512 representing the physical port where the data is transmitted. On the other side of the link, after a fixed delay for time-of-flight on the wire, the TSP 501 performing the Receive instruction can pull, for example, a 320-byte vector off the channel for every Receive issued.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

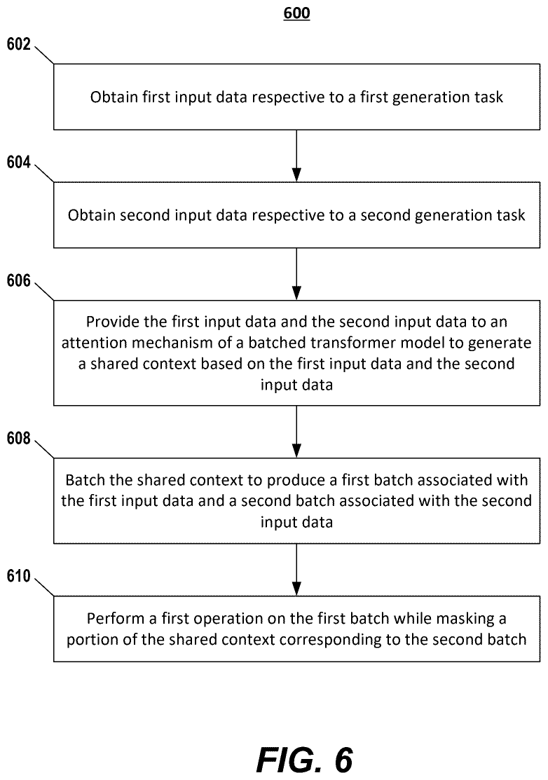

FIG. 6 illustrates a flowchart of an example method 600 for batch folding for parallelized multiuser computations according to example implementations of the present disclosure.

The method 600 can include, at 602, obtaining, by a computing system comprising one or more computing devices, first input data respective to a first generation task. This input data can include any suitable data such as text data, video data, or audio data, and can be represented as embedded or encoded representations such as numerical vectors that encode semantic meaning.

In some implementations, the first input data can be associated with a first user and the second input data can be associated with a second user. This configuration can provide for generating tokens for multiple users or multiple queries in a single evaluation of the transformer model by assigning multiple users to batches of a shared context.

The method 600 can include, at 604, obtaining, by the computing system, second input data respective to a second generation task. By batching multiple input sequences in parallel, the system can utilize a greater amount of the available sequence length, which can reduce computational resource waste associated with processing meaningless context values when a single query is smaller than the total sequence length capacity.

The method 600 can include, at 606, providing, by the computing system, the first input data and the second input data to an attention mechanism of a batched transformer model to generate a shared context based on the first input data and the second input data. The attention mechanism can provide for the transformer model to capture dependencies and contextual relationships between tokens even when tokens are not in close proximity within an input sequence.

In some implementations, the method can further include generating a key tensor, a query tensor, and a value tensor of the shared context. These tensors can be generated by multiplying the attention input by respective learned weight matrices to provide an expanded evaluation space for representing relationships between tokens.

In some implementations, the method can further include caching the key tensor and the query tensor in a key-value cache. Caching can provide for storing intermediate results computed during a forward pass so they can be reutilized for subsequent tokens, which can avoid redundant recalculations.

In some implementations, the method can further include performing a reduce sum operation and an all gather operation on each of the key tensor, the query tensor, and the value tensor. These operations can facilitate parallel computation by reducing data across functional units and collecting data to provide that all heads have access to the query information.

In some implementations, the method can further include performing a reshape operation on each of the key tensor, the query tensor, and the value tensor. Reshaping can reformat the tensors into dimensionalities that can be suitable for downstream processing, such as a query tensor format of [B, 64, T, 128].

In some implementations, the method can further include generating a K×Q tensor including a cross product of the key tensor and the query tensor. This similarity matrix can represent the raw attention scores between query and key pairs across the sequence length and token dimensions.

The method 600 can include, at 608, batching, by the computing system, the shared context to produce a first batch associated with the first input data and a second batch associated with the second input data. Batching can divide the total sequence length into a plurality of batches that can be treated as separate, related contexts.

In some implementations, batching the shared context can include generating a batch select matrix including data representative of whether a respective batch of the first batch or the second batch will be masked. The batch select matrix can provide for folding multiple portions of the shared context, including disjoint portions, into a single processing instance based on the context length utilized by a user.

The method 600 can include, at 610, performing, by the computing system, a first operation on the first batch while masking a portion of the shared context corresponding to the second batch. Masking can provide for isolating user-specific data to prevent cross-contamination between folded batches during processing.

In some implementations, the first operation can include a normalization operation operation, and masking the portion of the shared context can include multiplying the batch select matrix by the shared context. One example normalization operation is a SoftMax operation. Because SoftMax operations can scale with sequence length, reducing the active sequence length through masking can conserve computing resources.

In some implementations, the normalization operation (e.g., SoftMax operation) can include a ReduceMax operation and a ReduceSum operation, and the portion of the shared context can be masked during the ReduceMax operation and the ReduceSum operation. The ReduceMax operation can identify a largest value in the masked context for numerical stability, while the ReduceSum operation can calculate the denominator for normalization across the active sequence length.

In some implementations, the method can further include generating data indicative of attention scores based on an output of the normalization (e.g., SoftMax) operation. This operation can convert raw attention scores into a normalized probability distribution representing attention weights.

In some implementations, generating the data indicative of the attention scores can include performing a second operation on the first batch while masking a portion of the shared context corresponding to the second batch. This secondary masking can provide for reduced computational resource use by isolating relevant data during subsequent scoring.

In some implementations, the second operation can include determining a dot product of the shared context while masking the portion of the shared context corresponding to the second batch. This can include combining normalized attention weights with value representations to produce a weighted context tensor.

In some implementations, subsequent to performing the first operation on the first batch, the method can include transposing and reshaping an output of the first operation to remap the output of the first operation to a dimensionality of input to the attention mechanism. These operations can transform the attention output back into a dimensionality, such as [B, T, SL], that can match the feature space of the model input.

In some implementations, subsequent to transposing and reshaping the output of the first operation, the method can include performing a ReduceSum operation on the remapped output of the first operation while masking a portion of the remapped output corresponding to the second batch. This can provide for compressing the masked attention tensor across batch folding dimensions to prepare the output for subsequent feed-forward stages of the transformer model.

In an aspect, the present disclosure can provide a computer-implemented method for batch folding for parallelized multiuser computations. The method can include obtaining, by a computing system including one or more computing devices, first input data respective to a first generation task. The method can include obtaining, by the computing system, second input data respective to a second generation task. The method can include providing, by the computing system, the first input data and the second input data to an attention mechanism of a batched transformer model to generate a shared context based on the first input data and the second input data. The method can include batching, by the computing system, the shared context to produce a first batch associated with the first input data and a second batch associated with the second input data. The method can include performing, by the computing system, a first operation on the first batch while masking a portion of the shared context corresponding to the second batch.

In some implementations, the first input data can be associated with a first user and the second input data can be associated with a second user.

In some implementations, the method can further include generating a key tensor, a query tensor, and a value tensor of the shared context.

In some implementations, the method can further include caching the key tensor and the query tensor in a key-value cache.

In some implementations, the method can further include performing a reduce sum operation and an all gather operation on each of the key tensor, the query tensor, and the value tensor.

In some implementations, the method can further include performing a reshape operation on each of the key tensor, the query tensor, and the value tensor.

In some implementations, the method can further include generating a K×Q tensor including a cross product of the key tensor and the query tensor.

In some implementations, batching the shared context can include generating a batch select matrix including data representative of whether a respective batch of the first batch or the second batch will be masked.

In some implementations, the first operation can include a normalization operation, and masking the portion of the shared context can include multiplying the batch select matrix by the shared context.

In some implementations, the normalization operation can include a ReduceMax operation and a ReduceSum operation, and the portion of the shared context can be masked during the ReduceMax operation and the ReduceSum operation.

In some implementations, the method can further include generating data indicative of attention scores based on an output of the normalization operation.

In some implementations, generating the data indicative of the attention scores can include performing, by the computing system, a second operation on the first batch while masking a portion of the shared context corresponding to the second batch.

In some implementations, the second operation can include determining a dot product of the shared context while masking the portion of the shared context corresponding to the second batch.

In some implementations, subsequent to performing the first operation on the first batch, the method can include transposing and reshaping an output of the first operation to remap the output of the first operation to a dimensionality of input to the attention mechanism, the input to the attention mechanism including the first input data and the second input data.

In some implementations, subsequent to transposing and reshaping the output of the first operation, the method can include performing a ReduceSum operation on the remapped output of the first operation while masking a portion of the remapped output corresponding to the second batch.

In some implementations, the method further includes folding a plurality of disjoint portions of the shared context into the first batch.

In an aspect, the present disclosure can provide a computing system. The computing system can include one or more processors and one or more non-transitory, computer-readable media storing instructions that, when implemented, can cause the one or more processors to perform operations. The operations can include obtaining first input data respective to a first generation task. The operations can include obtaining second input data respective to a second generation task. The operations can include providing the first input data and the second input data to an attention mechanism of a batched transformer model to generate a shared context based on the first input data and the second input data. The operations can include batching the shared context to produce a first batch associated with the first input data and a second batch associated with the second input data. The operations can include performing a first operation on the first batch while masking a portion of the shared context corresponding to the second batch.

In some implementations, batching the shared context can include generating a batch select matrix including data representative of whether a respective batch of the first batch or the second batch will be masked.

In some implementations, the operations can further include, subsequent to performing the first operation on the first batch, transposing and reshaping an output of the first operation to remap the output of the first operation to a dimensionality of input to the attention mechanism, the input to the attention mechanism including the first input data and the second input data.

In an aspect, the present disclosure can provide one or more non-transitory, computer-readable media storing instructions that, when implemented, can cause one or more processors to perform operations. The operations can include obtaining first input data respective to a first generation task. The operations can include obtaining second input data respective to a second generation task. The operations can include providing the first input data and the second input data to an attention mechanism of a batched transformer model to generate a shared context based on the first input data and the second input data. The operations can include batching the shared context to produce a first batch associated with the first input data and a second batch associated with the second input data. The operations can include performing a first operation on the first batch while masking a portion of the shared context corresponding to the second batch.

In some implementations, batching the shared context can include generating a batch select matrix including data representative of whether a respective batch of the first batch or the second batch will be masked.

Aspects of the disclosure have been described in terms of illustrative implementations thereof. Numerous other implementations, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims, operations, or processes discussed herein can be adapted, rearranged, expanded, omitted, combined, or modified in various ways without deviating from the scope of the present disclosure. Some of the claims are described with a letter reference to a claim element for exemplary illustrated purposes and is not meant to be limiting. The letter references do not imply a particular order of operations. For instance, letter identifiers such as (a), (b), (c), . . . , (i), (ii), (iii), . . . , etc. can be used to illustrate operations. Such identifiers are provided for the ease of the reader and do not denote a particular order of steps or operations. An operation illustrated by a list identifier of (a), (i), etc. can be performed before, after, or in parallel with another operation illustrated by a list identifier of (b), (ii), etc.

What is claimed is:

1. A computer-implemented method, comprising:
obtaining, by a computing system comprising one or more computing devices, first input data respective to a first generation task;
obtaining, by the computing system, second input data respective to a second generation task;
providing, by the computing system, the first input data and the second input data to an attention mechanism of a batched transformer model to generate a shared context based on the first input data and the second input data;
batching, by the computing system, the shared context to produce a first batch associated with the first input data and a second batch associated with the second input data; and
performing, by the computing system, a first operation on the first batch while masking a portion of the shared context corresponding to the second batch.

2. The computer-implemented method of claim 1, wherein the first input data is associated with a first user and the second input data is associated with a second user.

3. The computer-implemented method of claim 1, further comprising generating a key tensor, a query tensor, and a value tensor of the shared context.

4. The computer-implemented method of claim 3, further comprising caching the key tensor and the query tensor in a key-value cache.

5. The computer-implemented method of claim 3, further comprising performing a reduce sum operation and an all gather operation on each of the key tensor, the query tensor, and the value tensor.

6. The computer-implemented method of claim 3, further comprising performing a reshape operation on each of the key tensor, the query tensor, and the value tensor.

7. The computer-implemented method of claim 3, further comprising generating a K×Q tensor comprising a cross product of the key tensor and the query tensor.

8. The computer-implemented method of claim 1, wherein batching the shared context comprises generating a batch select matrix comprising data representative of whether a respective batch of the first batch or the second batch will be masked.

9. The computer-implemented method of claim 8, wherein the first operation comprises a normalization operation, and wherein masking the portion of the shared context comprises multiplying the batch select matrix by the shared context.

10. The computer-implemented method of claim 9, wherein the normalization operation comprises a ReduceMax operation and a ReduceSum operation, and wherein the portion of the shared context is masked during the ReduceMax operation and the ReduceSum operation.

11. The computer-implemented method of claim 9, further comprising generating data indicative of attention scores based on an output of the normalization operation.

12. The computer-implemented method of claim 11, wherein generating the data indicative of the attention scores comprising performing, by the computing system, a second operation on the first batch while masking a second portion of the shared context corresponding to the second batch.

13. The computer-implemented method of claim 12, wherein the second operation comprises determining a dot product of the shared context while masking the second portion of the shared context corresponding to the second batch.

14. The computer-implemented method of claim 1, further comprising, subsequent to performing the first operation on the first batch, transposing and reshaping an output of the first operation to remap the output of the first operation to a dimensionality of input to the attention mechanism, the input to the attention mechanism comprising the first input data and the second input data.

15. The computer-implemented method of claim 14, further comprising, subsequent to transposing and reshaping the output of the first operation, performing a ReduceSum operation on the remapped output of the first operation while masking a portion of the remapped output corresponding to the second batch.

16. The computer-implemented method of claim 1, further comprising folding a plurality of disjoint portions of the shared context into the first batch.

17. A computing system, comprising:
one or more processors; and
one or more computer-readable media storing instructions that, when implemented, cause the one or more processors to perform operations, the operations comprising:
obtaining first input data respective to a first generation task;
obtaining second input data respective to a second generation task;
providing the first input data and the second input data to an attention mechanism of a batched transformer model to generate a shared context based on the first input data and the second input data;
batching the shared context to produce a first batch associated with the first input data and a second batch associated with the second input data; and
performing a first operation on the first batch while masking a portion of the shared context corresponding to the second batch.

18. The computing system of claim 17, wherein batching the shared context comprises generating a batch select matrix comprising data representative of whether a respective batch of the first batch or the second batch will be masked.

19. The computing system of claim 17, wherein the operations further comprise, subsequent to performing the first operation on the first batch, transposing and reshaping an output of the first operation to remap the output of the first operation to a dimensionality of input to the attention mechanism, the input to the attention mechanism comprising the first input data and the second input data.

20. One or more non-transitory, computer-readable media storing instructions that, when implemented, cause one or more processors to perform operations, the operations comprising:
obtaining first input data respective to a first generation task;
obtaining second input data respective to a second generation task;
providing the first input data and the second input data to an attention mechanism of a batched transformer model to generate a shared context based on the first input data and the second input data;
batching the shared context to produce a first batch associated with the first input data and a second batch associated with the second input data; and
performing a first operation on the first batch while masking a portion of the shared context corresponding to the second batch.
